(19) United States
(12) Patent Application Publication
(10) Pub. No.: US 2019/0030916 A1
(43) Pub. Date: Jan. 31, 2019

(54) LIGHT SCANNING APPARATUS

(71) Applicant: HOYA CANDEO OPTRONICS CORPORATION, Toda-shi (JP)

(72) Inventor: Shohei Matsuoka, Tokyo (JP)

(73) Assignee: HOYA CANDEO OPTRONICS CORPORATION, Toda-shi (JP)

(21) Appl. No.: 16/047,961

(22) Filed: Jul. 27, 2018

(30) Foreign Application Priority Data
Jul. 31, 2017 (JP) 2017-147956
Jul. 5, 2018 (JP) 2018-128524

(51) Int. Cl. B41J 2/44

(52) U.S. Cl. CPC B41J 2/442

(57) ABSTRACT

A light scanning apparatus includes a laser light source, an anamorphic element converging a laser beam from the laser light source in a sub-scan direction, a deflector deflecting and scanning the laser beam, an image-forming optical system converging the deflected laser beam in a scan direction onto a scan target surface, and a reflective member between the image-forming optical system and the scan target surface to reflect the laser beam onto the scan target surface. When an F value of axial beam in the scan direction is Fno, an F value of beam at a maximum image height in the scan direction is Fno′, and an incidence angle of beam at the maximum image height onto the scan target surface in the scan direction is α, the following Equation (1) is satisfied:

{1-(1-cos α⁴)/√M}/cos α⁴≥Fno′²/Fno²≥1/cos α⁴ (1)
where M is an arbitrary real number that is √2 or greater and 2 or smaller.

### TECHNICAL FIELD

The present disclosure relates to a light scanning apparatus such as a laser scanning unit (LSU) embedded in a laser beam printer, and more particularly, to a light scanning apparatus having a folding mirror between an image-forming optical system and a target surface.

### BACKGROUND ART

Conventionally, in a laser beam printer, a laser scanner and a barcode reader, a light scanning apparatus is used to scan a laser beam onto a predefined image plane. The light scanning apparatus includes a semiconductor laser, a collimator lens, an optical deflector such as a polygon mirror, and a fθ lens system (an image-forming optical system), and a laser beam emitted from the semiconductor laser penetrates the collimator lens and is directed to the optical deflector and scanned by rotation of the optical deflector, and the scanned laser beam forms an image on a target surface (for example, photoreceptors) through the fθ lens system.

Additionally, in such a light scanning apparatus, to reduce the size of the apparatus or adjust the emission angle, a folding mirror (a reflective mirror) may be installed between the fθ lens system and the target surface (for example, Patent Literature 1). Additionally, when two folding mirrors are used, a small change (for example, a position change of the photoreceptors) in configuration of the laser beam printer can be only responded by changing the arrangement of the folding mirrors, so the use of two folding mirrors to reduce the design cost and the design time is also provided for practical use.

The light scanning apparatus disclosed by Patent Literature 1 includes four light sources and two optical deflectors, an image-forming lens and a reflective mirror within a case, to reflect each scanning beam having passed through the image-forming lens onto the reflective mirror once or twice and guide to four photoreceptors corresponding to four colors, yellow, magenta, cyan and black.

Additionally, in such a light scanning apparatus, when there is bending (called upper surface bending) in the scanning beam that scans on the photoreceptors, a focus position is inaccurate and the spot diameter is too large, and thus reducing and suppressing the occurrence of upper surface bending is suggested (for example, Patent Literature 2).

The light scanning apparatus disclosed by Patent Literature 2 controls the aspheric surface shape of the lens with a predefined value of difference in beam diameter between a first surface and a second surface, to reduce upper surface bending when a curve occurs in the lens.

### RELATED LITERATURES

### Patent Literatures

Japanese Patent Publication No. 2012-145665

Japanese Patent Publication No. 2007-187739

### DISCLOSURE

### Technical Problem

According to the configuration disclosed by Patent Literature 1, each scanning beam is reflected by the reflective mirror once or twice and guided at the emission angle of approximately 90° for each photoreceptor. However, in the configuration disclosed by Patent Literature 1, because two ends of the long reflective mirror are supported in the case, when the case shrinks or expands by heat, a curve occurs in the reflective mirror. Additionally, when a curve occurs in the reflective mirror, the scanning beam that scans on the photoreceptors is bent (upper surface bending) or the spot diameter at the surrounding image height is too large due to the degraded optical performance. For example, as described in Patent Literature 1, when the scanning beam is reflected twice by two reflective mirrors, a risk of change in spot diameter increases a maximum of 2 times and √2 times as a predicted value. For this reason, in Patent Literature 1, through a thorough analysis of temperature distribution in the light scanning apparatus, an amount of curve of the folding mirror is adjusted to cancel the upper surface bending caused by thermal deformation of the lens surface in the image-forming optical system and the upper surface bending caused by thermal deformation of the folding mirror. However, in this configuration, from the perspective of correcting the upper surface bending, since the position of the image-forming optical system, the position of the folding mirror and the position of the photoreceptors are fixed in design, it is impossible to easily respond to a small change in configuration of the laser beam printer. Specifically, when the temperature distribution in the light scanning apparatus changes with a change in the position of a heat source in the laser beam printer, the upper surface bending cancellation effect is not exerted. Additionally, when the distance between photoreceptors changes, if the angle of the folding mirror is changed in response, the upper surface bending cancellation effect loses.

Additionally, technique to suppress the upper surface bending at a group of optical elements includes the configuration disclosed by Patent Literature 2, and the configuration disclosed by Patent Literature 2 can reduce and suppress upper surface bending in the event that a curve occurs in the lens, but cannot apply to upper surface bending caused by the curve of the reflective mirror with a single planar surface.

In this context, the present disclosure is directed to providing a light scanning apparatus capable of reducing and suppressing upper surface bending caused by the curve of the reflective mirror irrespective of the configuration of the reflective mirror positioned at the rear end of the image-forming optical system.

### Technical Solution

Upon careful review, the inventor found that in a light scanning apparatus for focusing and scanning a laser beam onto a scan target surface, it is possible to reduce and suppress upper surface bending caused by the curve of a reflective mirror (a reflective member) positioned at the rear end of an image-forming optical system by adjusting an F value of the image-forming optical system. The present disclosure is based on the findings.

That is, a light scanning apparatus of the present disclosure includes a laser light source which emits a laser beam, an anamorphic element which converges the laser beam emitted from the laser light source primarily in a sub-scan direction, a deflector which deflects and scans the laser beam converged by the anamorphic element, an image-forming optical system which converges the laser beam deflected by the deflector as a spot scanning in a scan direction onto a scan target surface, and a reflective member positioned between the image-forming optical system and the scan target surface to reflect the laser beam emitted from the image-forming optical system onto the scan target surface, wherein when an F value of axial beam of the image-forming optical system in the scan direction is Fno, an F value of beam at a maximum image height in the scan direction is Fno′, and an incidence angle of beam at the maximum image height onto the scan target surface in the scan direction is α, the following Equation (1) is satisfied:

{1-(1-cos α⁴)/√M}/cos α⁴≤Fno′²/Fno²≤1/cos α⁴ (1)

where M is an arbitrary real number that is √2 or greater and 2 or smaller. Additionally, the image-forming optical system may be configured to have a property represented by the following Equation (2) when an image height is Y, a focal length is f, and an incidence angle of laser beam is θ:

Y=Nf·tan(θ/N) (2)

where N is an arbitrary real number that is 2 or greater and 10 or smaller.

Additionally, the image-forming optical system satisfies the following Equation (3) at an image height 0, and when an incidence angle of laser beam at a maximum image height is 8, the image-forming optical system satisfies the following Equation (4):

d³(Y/f)/dθ³=2/N²×(π/180)² (3)

d(Y/f)/dθ=1 /cos(θ/N′)² (4)

where preferably, each of N and N′ is an arbitrary real number that is 2 or greater and 10 or smaller, and satisfies the following Equation (5):

0≤N′−N≤1 (5)

Additionally, in this case, when an image height is Y and a focal length is f, the image-forming optical system has a property represented by the following Equation (6):

Y=nf·tan(θ/n) (6)

where preferably, n monotonically increases from N to N′ toward the maximum image height from the image height 0.

Additionally, preferably, the N is 2 or greater and 3 or smaller.

Additionally, the reflective member may include a first reflective mirror and a second reflective mirror each with an approximately planar mirror surface, the first reflective mirror may be configured to reflect emitted the laser beam from the image-forming optical system onto the second reflective mirror, and the second reflective mirror may be configured to reflect the laser beam emitted from the first reflective mirror onto the scan target surface.

### Advantageous Effects

As described above, according to the light scanning apparatus of the present disclosure, it is possible to reduce and suppress upper surface bending caused by the curve of the reflective mirror irrespective of the configuration of the reflective mirror positioned at the rear end of the image-forming optical system.

### DESCRIPTION OF DRAWINGS

FIG. 1 is a plane view showing the arrangement of optical elements of a light scanning apparatus according to an embodiment of the present disclosure.

FIG. 2 is a diagram illustrating a problem when a curve occurs in a reflective mirror of a light scanning apparatus according to an embodiment of the present disclosure.

FIG. 3 is a diagram illustrating a laser beam that converges on a scan target surface when a conventional fθ lens is applied as an image-forming optical system.

FIG. 4 is a diagram illustrating a laser beam on a reflective mirror when a conventional fθ lens is applied as an image-forming optical system.

FIG. 5 is a diagram illustrating the influence on a laser beam when a curve occurs in the reflective mirror of FIG. 4.

FIG. 6A and FIG. 6B, respectively, show the results of simulating the influence of wavefront aberration caused by the curve of a reflective mirror on the spot diameter.

FIG. 7 is a graph showing a relationship of each property of an image-forming optical system, an incidence angle θ, and a scanning speed of laser beam of a light scanning apparatus according to an embodiment of the present disclosure.

FIG. 8 is a graph showing the scanning properties of a light scanning apparatus of example 1 of the present disclosure.

FIG. 9 is a plane view showing the arrangement of optical elements of a light scanning apparatus of example 2 of the present disclosure.

FIG. 10 is a graph showing the scanning properties of a light scanning apparatus of example 2 of the present disclosure.

FIG. 11 is a plane view showing the arrangement of optical elements of a light scanning apparatus of comparative example 1 of the present disclosure.

FIG. 12 is a graph showing the scanning properties of a light scanning apparatus of comparative example 1 of the present disclosure.

FIG. 13 is a plane view showing the arrangement of optical elements of a light scanning apparatus of example 3 of the present disclosure.

FIG. 14 is a graph showing the scanning properties of a light scanning apparatus of example 3 of the present disclosure.

FIG. 15 is a graph illustrating a scanning speed of a light scanning apparatus of example 3.

FIG. 16 is a graph illustrating changes in acceleration of a light scanning apparatus of example 3.

### BEST MODE

Hereinafter, the embodiments of the present disclosure will be described in detail with reference to the accompanying drawings. Additionally, in the drawings, identical or equivalent elements are given identical reference symbols and their description is not repeated.

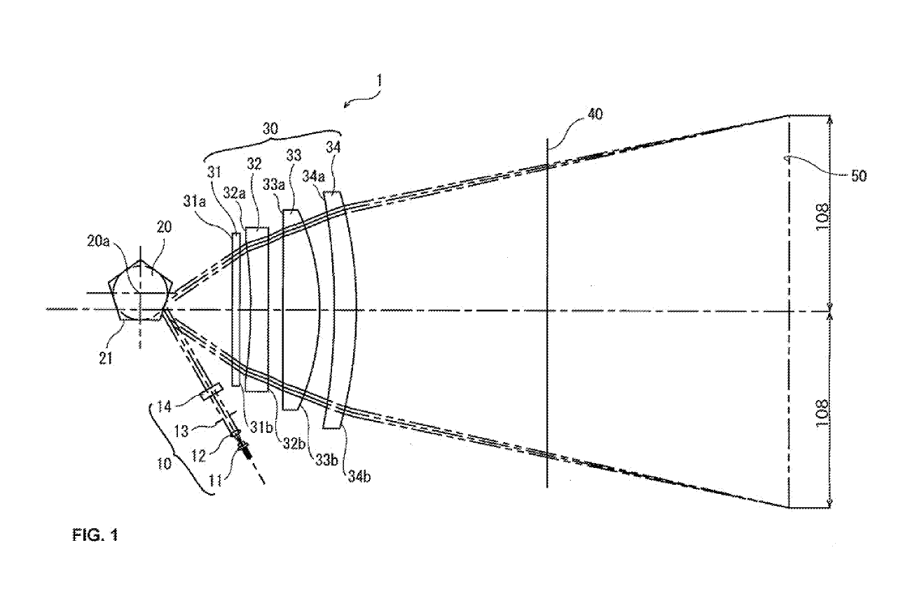

FIG. 1 is a plane view in scan direction showing the arrangement of optical elements of a light scanning apparatus 1 according to an embodiment of the present disclosure. The light scanning apparatus 1 of this embodiment is used as a laser scanning unit (LSU) of a laser beam printer, and scans an ON/OFF modulated laser beam onto a scan target surface 50 such as a photoreceptor drum according to an inputted telewriting signal, forming an electrostatic latent image. In the specification, a direction in which a spot scans on the scan target surface 50 is defined as a scan direction (Y axis), a direction perpendicular to this is defined as a sub-scan direction (Z axis), and the shape of each optical element and the direction of power are described on the basis of the direction on the scan target surface 50.

As shown in FIG. 1, the light scanning apparatus 1 of this embodiment reflects and deflects a laser beam emitted from a light source unit 10 by an optical deflector or a polygon mirror 20, and converges the reflected laser beam as a spot onto the scan target surface 50 by an image-forming optical system 30. Additionally, the light scanning apparatus 1 of this embodiment includes a reflective mirror 40 between the image-forming optical system 30 and the scan target surface 50 to reflect the laser beam emitted from the image-forming optical system 30 onto the scan target surface 50. Additionally, the laser beam emitted from the light scanning apparatus 1 of this embodiment is configured to scan the range of image height±108 mm (i.e., the range of A4 size) on the scan target surface 50. The light source unit 10 includes a semiconductor laser 11 (a laser source) having a single light emitting point or a plurality of light emitting points arranged in array form or sheet form, a collimator lens 12 to change a divergent light emitted from the semiconductor laser 11 to a parallel light, a slit 13 to shape the parallel light emitted from the collimator lens 12 into a predefined beam size, and an anamorphic lens (anamorphic element) 14 having positive power primarily in the sub-scan direction, to allow the laser beam that is modulated according to a telewriting signal (not shown) to be incident onto the polygon mirror 20 from the outside of the beam scanning range by the polygon mirror 20. Additionally, for the anamorphic lens 14, a cylindrical lens having positive power only in the sub-scan direction may be used, and a toric lens having positive power in the sub-scan direction and lower power than that of the sub-scan direction in the scan direction may be used.

The polygon mirror 20 has five reflective surfaces 21, and is rotatably installed by clockwise rotation in the drawing around a rotation axis 20a that is perpendicular to the main scan surface. The image-forming optical system 30 is a member that refracts the laser beam reflected by the polygon mirror 20 to scan on the scan target surface 50 at a predefined speed (i.e., predefined scanning properties) and converges as a spot, and includes a correction plate 31, a first lens 32, a second lens 33 and a third lens 34 from the polygon mirror 20 side to the scan target surface 50 side. The correction plate 31 is a plate-shaped member that corrects asymmetric sub-scan upper surface bending created by a change in reflection position of the polygon mirror 20 occurring by the image height. More specifically, in this embodiment, the first lens 32, the second lens 33 and the third lens 34 are all made of glass. Additionally, the correction plate 31 is a member having an aspheric surface shape with ultraviolet curable resin on the surface of a glass plane plate, and the refractive indices of the glass plane plate and the ultraviolet curable resin are set to be approximately equal so that optical phenomena at the interface of the glass plane plate and the ultraviolet curable resin is negligible. Accordingly, in the specification, it is described below that there is no influence of the interface of the glass plane plate and the ultraviolet curable resin. Additionally, in this embodiment, it is described that a surface on the polygon mirror 20 side of the correction plate 31 is a first surface 31a, a surface on the scan target surface 50 side is a second surface 31b, a lens surface of the polygon mirror 20 side of the first lens 32 is a first surface 32a, a lens surface on the scan target surface 50 side is a second surface 32b, a lens surface of the polygon mirror 20 side of the second lens 33 is a first surface 33a, a lens surface on the scan target surface 50 side is a second surface 33b, a lens surface of the polygon mirror 20 side of the third lens 34 is a first surface 34a, and a lens surface on the scan target surface 50 side is a second surface 34b.

The reflective mirror 40 is a long mirror element that is positioned between the image-forming optical system 30 and the scan target surface 50 to reflect the laser beam emitted from the image-forming optical system 30 onto the scan target surface 50, and in this embodiment, inside a case (housing) not shown, its two ends are supported and fixed to mirror retaining elements (not shown). Additionally, in FIG. 1, for convenience of description, a mirror surface of only one reflective mirror 40 is indicated by a straight line, but a plurality of reflective mirrors 40 may be arranged. That is, the reflective mirror 40 of this embodiment may include a first reflective mirror 40 and a second reflective mirror 40 each having an approximately planar mirror surface, and in this case, the first reflective mirror 40 is configured to reflect the laser beam emitted from the image-forming optical system 30 onto the second reflective mirror 40, and the second reflective mirror 40 is configured to reflect the laser beam emitted from the first reflective mirror 40 onto the scan target surface 50.

The light emitted from the semiconductor laser 11 becomes a parallel beam by the collimator lens 12, and is shaped into a predefined beam size by the slit 13. Additionally, the laser beam having passed through the slit 13 forms a linear shape near the polygon mirror 20 through the anamorphic lens 14.

The laser beam reflected off the polygon mirror 20 is incident onto the image-forming optical system 30 as an approximately parallel light in the scan direction and a divergent light in the sub-scan direction. Additionally, the laser beam penetrating the image-forming optical system 30 is reflected by the reflective mirror 40, to form a spot on the scan target surface 50. The spot scans on the scan target surface 50 in the scan direction at a predefined speed (i.e., predefined scanning properties) by rotation of the polygon mirror 20, followed by synchronization and modulation of the semiconductor laser 11, to form an electrostatic latent image on the scan target surface 50.

Here, as described above, the reflective mirror 40 of this embodiment is a long mirror that is positioned between the image-forming optical system 30 and the scan target surface 50 to reflect the laser beam emitted from the image-forming optical system 30 onto the scan target surface 50, and inside the case (housing) not shown, its two ends are supported and fixed by the mirror retaining elements (not shown), and in this configuration, when the case shrinks or expands by heat, the distance between the mirror retaining elements (not shown) changes, and the reflective mirror 40 is bent (i.e., a curve occurs). Additionally, when a curve occurs in the reflective mirror 40, the laser beam that scans on the scan target surface 50 is bent (i.e., so-called upper surface bending occurs), or the optical performance degrades, so the spot diameter at the surrounding image height is too large. Thus, in this embodiment, to solve this problem (i.e., to reduce and suppress the upper surface bending caused by the curve of the reflective mirror 40), the following conditional expression (1) is satisfied when an F value of axial beam of the image-forming optical system 30 in the scan direction is Fno, an F value of beam in the scan direction at the maximum image height (i.e., ±108 mm) is Fno′, and an incidence angle of beam onto the scan target surface 50 in the scan direction at the maximum image height (i.e., ±108 mm) is α. Additionally, in the specification, when an absolute value of an angle formed by the upper ray and the lower ray in the cross section of axial beam in the scan direction near the upper surface is γ, 1/Fno=2/sin(γ/2) is defined as an F value of axial beam in the scan direction. Likewise, when an absolute value of an angle formed by the upper ray and the lower ray in the cross section of off-axial beam in the scan direction near the upper surface is γ′, 1/Fno′=2/sin(γ′/2) is defined as an F value of off-axial beam in the scan direction. In the scanning system, because the F value is dark and γ and γ′ are small, it is regarded as 1/Fno=2/sin(γ/2)=2/tan(γ/2)≈γ, 1/Fno′=2/sin(γ′/2)=2/tan(γ′/2)≈γ′.

{1-(1-cos α⁴)/√M}/cos α⁴≤Fno′²≤1/cos α⁴ (1)

Additionally, in the conditional expression (1), M is an arbitrary real number that is √2 or greater and 2 or smaller.

Additionally, as described below, the image-forming optical system 30 is configured to have the property represented by the following Equation (2) when an image height is Y, a focal length is f, and an incidence angle of laser beam is θ.

Y=Nf·tan(θ/N) (2)

where N is an arbitrary real number that is 2 or greater and 10 or smaller.

Hereinafter, the characteristic configuration of the present disclosure (i.e., reducing and suppressing the upper surface bending caused by the curve of the reflective mirror 40) will be described in detail.

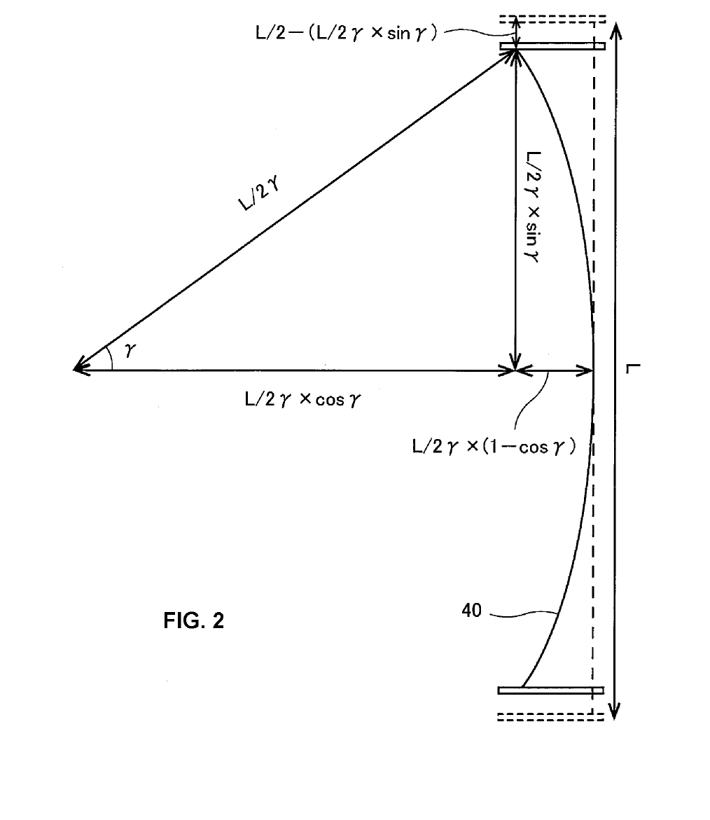

FIG. 2 is a diagram illustrating a problem when a curve occurs in the reflective mirror 40. As shown in FIG. 2, when a length of the reflective mirror 40 in natural state is L, an amount of shrinking of the case by heat (i.e., a variation in the length L of the reflective mirror 40) is K, a curvature is C when a curve occurs in the reflective mirror 40, and an angle formed by the end of the reflective mirror 40 and the curvature center is γ, the following Equations (3) and (4) are given.

K=2×{L/2−(L/2γ×sin γ)} (3)

C=2γ/L (4)

Additionally, the Taylor series expansion for Equation (3) yields the following Equation (5).

K=2×{L/2−(L/2γ×(γ−γ³/3!. . . ))}=Lγ²/6 (5)

Additionally, writing Equations (4) and (5), the following Equation (6) is obtained.

C=√(24 K/L³) (6)

Here, Equation (6) assumes the worst case of the bending (curvature C) of the reflective mirror 40, and because it also assumes the case in which the direction of curve is opposite, a value for the curvature C of the reflective mirror 40 is thought to be the following Equation (7).

−√(24 K/L³)≤C≤√(24 K/L³) (7)

Additionally, as described above, this embodiment may be configured to have a plurality of reflective mirror 40, and for example, in the case of two reflective mirrors 40, because each is bent, the influence of Equation (7) is thought to be a maximum of 2 times. However, each reflective mirror 40 is not necessarily bent in the same direction, and each may act in a direction in which the influence of bending cancels out, and accordingly, the influence of Equation (7) is expected to be about √2 times as a predicted value.

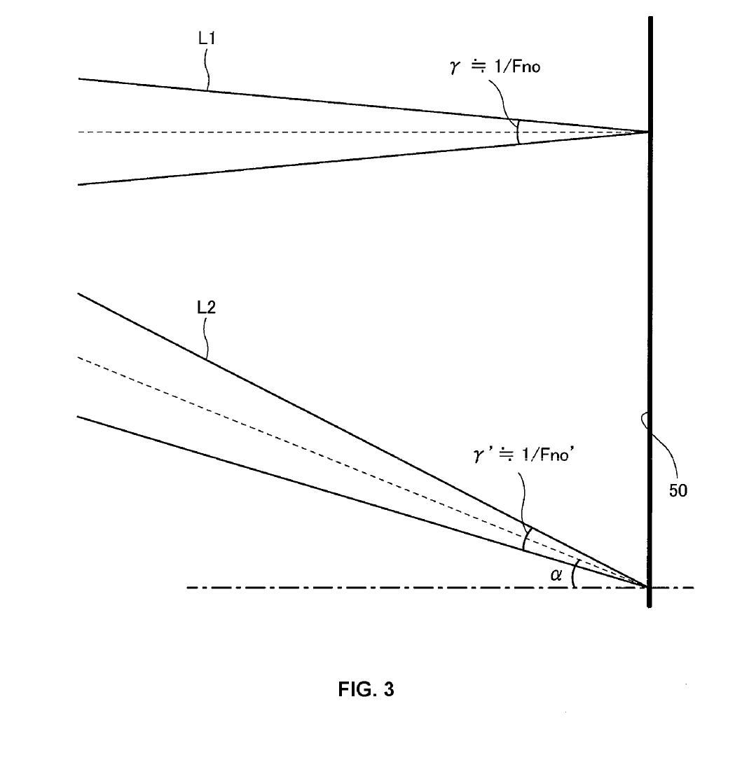

FIG. 3 is a diagram illustrating a laser beam that converges on the scan target surface 50 when the conventional (general) fθ lens is applied as the image-forming optical system 30, in where L1 denotes an axial beam, and L2 denotes an off-axial beam. As shown in FIG. 3, when an F value drawn from the inverse number of each y formed by the upper ray and the lower ray of the axial beam L1 is Fno, an F value drawn from the inverse number of each γ′ formed by the upper ray and the lower ray of the off-axial beam L2 is Fno′, an incidence angle of the off-axial beam L2 in the scan direction is a, and an emission wavelength of the semiconductor laser 11 is A, an axial spot diameter W0 in focus may be represented by the following Equation (8).

W0=(4λ/π)·Fno (8)

Additionally, an off-axial spot diameter W0′ in focus increases as much as an oblique incidence on the scan target surface 50, and may be represented by the following Equation (9).

W0′=(4λ/π)·Fno′/cos α (9)

Additionally, the conventional (general) fθ lens is a lens having a change in F value such that the off-axial F value is brighter as represented by the following Equation (10), in that axial and off-axial spot diameters are uniform. Additionally, because the depth of focus is proportional to the square of the F value, an off-axial depth of focus is narrow.

Fno′=Fno·cos α (10)

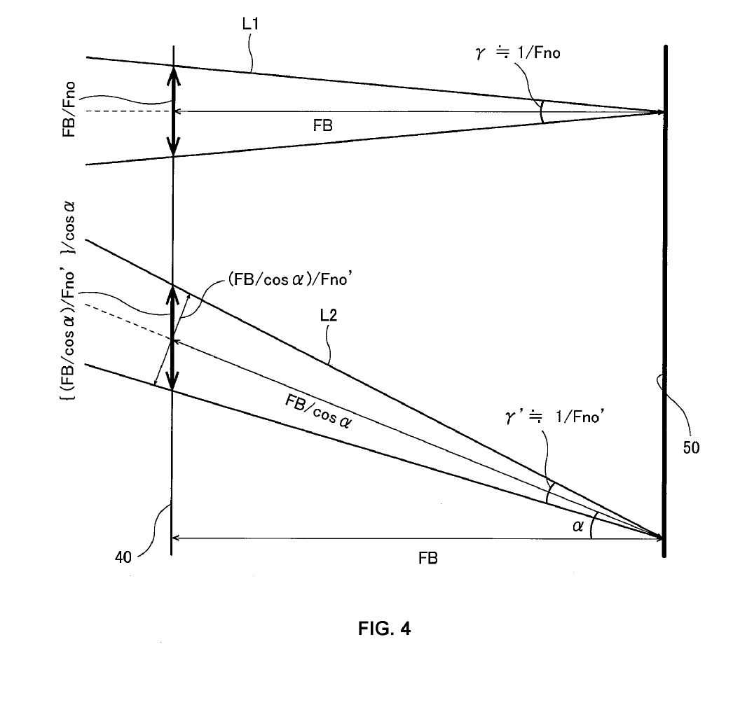

FIG. 4 is a diagram illustrating a laser beam on the reflective mirror 40 when the conventional (general) fθ lens is applied as the image-forming optical system 30. Similar to FIG. 3, L1 of FIG. 4 denotes an axial beam, and L2 denotes an off-axial beam.

As shown in FIG. 4, when the reflective mirror 40 is apart from the scan target surface 50 by a back focus FB along the optical axis, an axial beam diameter H and an off-axial beam diameter H′ on the reflective mirror 40 may be represented by the following Equations (11) and (12) using approximation of 1/Fno=2/sin(γ/2)=2/tan(γ/2).

H=FB/Fno (11)

H′=FB/(Fno′·cos α²) (12)

Here, substituting Equation (10) into Equations (11) and (12) respectively yields Equations (13) and (14).

H=FB·cos α/Fno′ (13)

H′=FB/(Fno·cos α³) (14)

That is, it can be seen that in the conventional (general) fθ lens, the main scanning beam diameter on the folding mirror is inversely proportional to the square root of cos3 of the incidence angle α.

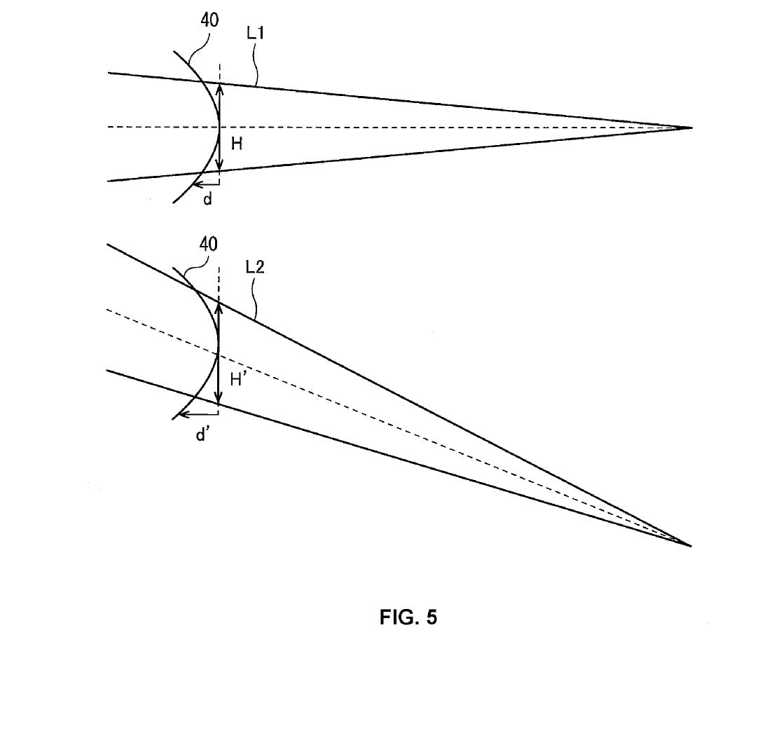

FIG. 5 is a diagram illustrating the influence on the laser beam when a curve occurs in the reflective mirror 40 in FIG. 4. In the same way as FIGS. 3 and 4, L1 of FIG. 5 denotes an axial beam, and L2 denotes an off-axial beam.

By the curve of the reflective mirror 40, a wavefront aberration D0 at the end of the axial beam L1 and a wavefront aberration D0′ at the end of the off-axial beam L2 are represented by the following Equations (15) and (16) when an amount of curve of the reflective mirror 40 per axial beam diameter (a quadratic functional variation) is d, an amount of curve of the reflective mirror 40 per off-axial beam diameter is d′, and a curvature of the curved reflective mirror 40 is C.

D0=2d/λ=2×0.5 C×(H/2)²/λ=C/4λ×H² (15)

D0′=2d′/λ=2×0.5 C×(H′/2)²/λ=C/4λ×H′² (16)

Here, the quadratic functional wavefront aberration of wavefront aberration D0 at the end of the axial beam L1 is called out-of-focus, and may be adjusted by shifting the position of the collimator lens 12. Additionally, this adjustment is equivalent to uniform shift of wavefront aberration quantities of the total image height. Additionally, because it is easy to identify an adjustment amount till the last due to a shallow depth of focus and ensure the performance of the off-axial beam L2 that is more likely to increase the spot, it is desirable to adjust on the basis of the off-axial beam L2. Additionally, when the wavefront aberration D0 at the end of the axial beam L1 and the wavefront aberration D0′ at the end of the off-axial beam L2 are adjusted, the wavefront aberration D0′ of the off-axial beam L2 becomes zero, and the wavefront aberration D′ of the axial beam L1 after adjustment becomes the following equation (17).

D′=D0−D0′=C/4λ×(H′²−H²) (17)

Additionally, substituting Equations (13) and (14) into Equation (17) yields the following equation (18).

D′={1/Fno²-1/(Fno′²·cos α⁴)}×FB²×C/4 λ (18)

Additionally, in the case of the conventional (general) fθ lens, substituting Equation (10) into Equation (17) yields the following equation (19).

D′={cos α²/Fno′²−1/(Fno′²·cos α⁴)}×FB²×C/4λ (19)

As described above, there is a difference in wavefront aberration occurring in the axial beam L1 and the off-axial beam L2, and although the wavefront aberration D0′ was adjusted, aberration remains in the axial beam L1.

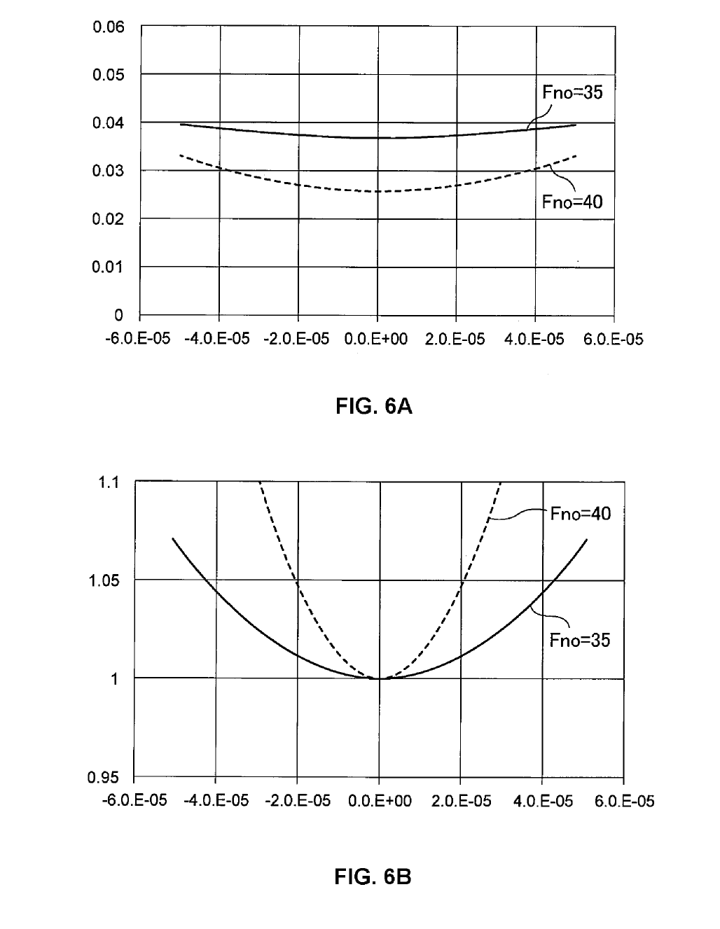

FIG. 6 shows the simulation results of the influence of the wavefront aberration on the spot diameter, FIG. 6A is a graph plotting the quadratic function shaped wavefront aberration D′ (Unit: mm) on horizontal axis and the simulated spot diameter W′ (Unit: mm) on the vertical axis, and FIG. 6B is a graph when the graph of FIG. 6A is standardized with the stigmatic spot diameter W0′ being 1. Additionally, FIG. 6 shows the F values of the axial beam L1, Fno=35 and Fno=40, when the incidence angle α=15° of the off-axial beam L2 in the scan direction and the emission wavelength λ=650 nm of the semiconductor laser 11.

As shown in FIG. 6, under the same light source, the spot diameter W′ in the presence of wavefront aberration is determined by the design spot diameter W0′ and the wavefront aberration D′, and may be presented by the following Equation (20).

W′=W0′×{1+(2·π²×D′²)} (20)

Here, as the design spot diameter W0′=(4λ/π)·Fno′/cos α, the spot diameter variation ΔW may be represented by the following Equation (21), and as the F value is larger, the variation ΔW is larger (see FIG. 6B).

ΔW′=W′−W0′=8πγ×Fno′/cos α×D′² (21)

Additionally, substituting Equation (18) into Equation (21), a relationship of the curvature C of the curved reflective mirror 40 and the spot diameter variation ΔW may be represented by the following Equation (22).

ΔW′=8πγ×Fno′/cos α×{(1/(Fno′²·cos α⁴)−1/Fno²)×FB²×C/4λ}² (22)

Additionally, substituting Equation (6) into Equation (22) yields Equation (23).

ΔW′=K×(192π/λL³)×Fno′/cos α×{(1/Fno²−1/(Fno′²·cos α⁴))×FB²}² (23)

Additionally, in the case of the conventional (general) fθ lens, substituting Equation (19) into Equation (21) yields the following Equation (24).

ΔW′=K×(192π/λL³)×Fno′/cos α×{(Fno′²·cos α⁴)−cos α⁴)−cos α²/Fno′²)×FB²}² (24)

As described above, the spot diameter variation ΔW of axial beam caused by the curve of the reflective mirror 40 may be represented by Equation (23) or (24), and in Equations (23) and (24), because the emission wavelength λ of the semiconductor laser 11 and the back focus FB are a preset quantity in the fundamental configuration of the light scanning apparatus 1, it can be seen that it is necessary to adjust the incidence angle α onto the scan target surface 50 or the F value to reduce and suppress the spot diameter variation ΔW. Here, to reduce the incidence angle α, the image-forming optical system 30 may be a telecentric optical system, but because the telecentric system needs to satisfy the condition in which the distance from the pupil to the principal point of the lens is equal to the focal length, there is a problem that the light scanning apparatus 1 increases in size. Thus, in this embodiment, to solve this problem (i.e., to reduce and suppress the spot diameter variation ΔW), the F value is adjusted. Additionally, when the F value is changed from the properties of the general fθ lens, the properties of the fθ lens, constant velocity and uniformity of spot diameter are damaged, and it is difficult to correct dynamic nonuniformity resulting from a temperature change, while it is easy to electrically (i.e., adjust the modulation frequency of the semiconductor laser 11) correct static nonuniformity set in design. Additionally, as described above, in the conventional fθ lens, because the F value of off-axial beam brighter than axial is a factor that changes the spot diameter, a method for adjusting the F value includes a method that makes the axial F value relatively bright, or a method that makes the off-axial F value relatively dark, and when the method that makes the off-axial F value relatively dark is employed, there is a problem that the design spot diameter is too large. Thus, in this embodiment, the method that makes the axial F value relatively bright is employed to electrically correct nonuniformity in the design spot diameter, and reduce and suppress the spot diameter variation ΔW caused by the bending of the reflective mirror 40. Specifically, in this embodiment, the image-forming optical system 30 is configured such that the spot diameter variation ΔW caused by the bending of the reflective mirror 40 is small compared to the configuration using the conventional fθ lens. Additionally, as described above, because in the case of two reflective mirrors 40, the spot diameter variation ΔW is larger √2 times as a predicted value and 2 times as a maximum value, the spot diameter variation ΔW is configured to be 1/√2 or less, and ideally 1/2 or less compared to the conventional (general) fθ lens. That is, the light scanning apparatus 1 of this embodiment is configured to satisfy the following Equation (25). Additionally, in Equation (25), M is a coefficient, and in this embodiment, M is an arbitrary real number that is √2 or greater and 2 or smaller.

M×K×(192π/λL³)×Fno′/cos α×{(1/(Fno′²·cos α⁴−1/Fno²))×FB²}²≤K×(192π/λL³)×Fno′/cos α×{(1/(Fno′²·cos α⁴)−cos α²/Fno′²)×FB²}² (25)

Additionally, writing Equation (25), the following Equation (26) is obtained.

{1−(1-cos α⁴)/√M}/cos α⁴≤Fno′²/Fno² (26)

where M is an arbitrary real number that is √2 or greater and 2 or smaller.

Here, if the axial beam diameter H and the off-axial beam diameter H′ are set equal in design, a problem with changes in spot diameter will not occur, and thus the following Equation (27) becomes a specific value from Equations (11) and (12).

Fno=Fno′cos α² (27)

Here, the condition that makes the axial F value brighter than Equation (27) does not need to select it, because both nonuniformity in design static spot diameter and changes in dynamic spot diameter with changes in temperature increase. Accordingly, it is thought to be reasonable to satisfy the following Equation (28).

Fno≥Fno′cos α²

1 /cos α⁴≥Fno′²/Fno² (28)

Additionally, writing Equations (27) and (28), the above-described conditional expression (1) is obtained as below.

{1 -(1-cos α⁴)/√M}/cos α⁴≤Fno′²≤1/cos α⁴ (1)

where M is an arbitrary real number that is √2 or greater and 2 or smaller.

As described above, the light scanning apparatus 1 of this embodiment is configured to satisfy the conditional expression (1), thereby reducing the upper surface bending caused by the curve of the reflective mirror 40. Additionally, because the conditional expression (1) does not include the length L of the reflective mirror and the distance FB from the scan target plane to the reflective mirror, it is possible to freely arrange the reflective mirror 40 without any influence of the arrangement or configuration of the reflective mirror 40 on the upper surface bending correction effect. That is, in view of the conventional configuration limited to cancelling out the upper surface bending caused by thermal deformation of the lens surface in the image-forming optical system, and the upper surface bending caused by thermal deformation of the reflective mirror, or setting the thickness or angle of the reflective mirror to a predefined value to prevent the thermal deformation of the reflective mirror, it was found that the degree of freedom of arrangement was greatly improved. Additionally, the conditional expression (1) is satisfied at the position of maximum image height±108 mm, and because originally there is no change in spot diameter at an area with low image height (i.e., an area with a small incidence angle α onto the scan target surface 50), there is no need to satisfy the conditional expression (1). However, the light scanning apparatus 1 that scans the range of image height±108 mm is preferably configured to smoothly change in properties between axial (i.e., image height 0 mm) and maximum image height±108 mm. Thus, the image-forming optical system 30 of this embodiment is configured to have the intermediate property of Y=fθ and Y=tan θ when the image height is Y, the focal length is f, and the incidence angle of the laser beam incident onto the image-forming optical system 30 is θ. That is, according to representation of a so-called fish-eye lens, when represented in the form of Y=Nf·tan(θ/N) (where N is a real number that is 1 or greater), it is configured to have the intermediate property of Y=fθ when N=1 and Y=f·tan θ=1·tan(θ/1) when N→∞, and for example, the property of Y=2f·tan(θ/2), Y=3f·tan(θ/3).

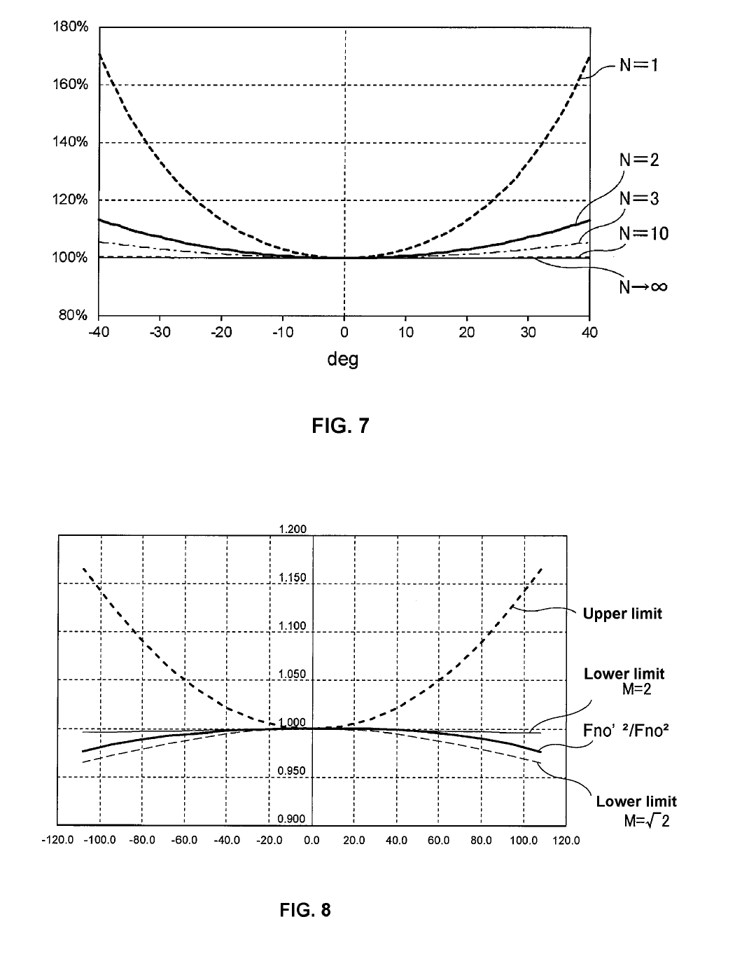

FIG. 7 is a graph showing a relationship of each property of the image-forming optical system 30 (N=1, 2, 3, 10, ∞), the incidence angle θ (horizontal axis: deg), and the scanning speed of laser beam (vertical axis: %). Additionally, in FIG. 7, the scanning speed (vertical axis: %) is represented as a relative value at the scanning speed of axial (i.e., image height 0 mm) laser beam of 100%. As shown in FIG. 7, it can be seen that when the value of N is close to ∞, a completely constant velocity is obtained. In effect, it can be also seen that if it is over N=10, a sufficiently constant velocity is achieved. On the contrary, when N=2, 3, there is a problem that with the increasing incidence angle θ (i.e., increasing image height), the scanning speed of laser beam is faster. Thus, in this embodiment, the modulation frequency of the semiconductor laser 11 changes depending on the scan position of laser beam (i.e., depending on the image height), thereby absorbing a change in scanning speed of laser beam. That is, the modulation frequency of the semiconductor laser 11 is adjusted so that it slowly changes between axial (i.e., image height 0 mm) and maximum image height±108 mm according to the properties of the image-forming optical system 30, and by this, an one-dot spot diameter formed on the scan target surface 50 is uniform.

Hereinafter, the detailed configuration of the light scanning apparatus 1 of this embodiment will be described through example (example 1, example 2) and comparative example (comparative example 1). Additionally, example 1, example 2 and comparative example 1 all set F values for design wavelength 830 nm, f=230 mm, off-axial beam diameter=40 μm. Additionally, a cylindrical lens having no power in in the scan direction is used as the anamorphic lens 14. Additionally, the polygon mirror 20 has five surfaces and a radius of an inscribed circle=14.8 mm with the rotation center being set at the position of 9 mm in Y axis and −12.8 mm in the optical axis direction. Additionally, it is assumed that the reflective mirror 40 has the length of 270 mm, and is positioned with two ends supported on the mirror retaining elements (not shown) at the position of 200 mm (i.e., Back Focus FB=200) from the scan target surface 50.

### EXAMPLE 1

The light scanning apparatus 1 of example 1 is shown in FIG. 1, and employs the image-forming optical system 30 having the property of Y=3f·tan(θ/3). Table 1 is a table showing the detailed numerical value configuration of this example, and in Table 1, the character R is a curvature radius of each optical element in the scan direction (Unit: mm), Rz is a curvature radius in the sub-scan direction (omitted in the case of a rotationally symmetric surface, Unit: mm), D is a distance on the optical axis between planes (Unit: mm), and nλ is a refractive index at the design wavelength. Additionally, ┌R1┘ of each optical element denotes a first surface (an incident surface), and ┌R2┘ denotes a second surface (an exit surface).

TABLE 1

| Name | R | Rz | D | nλ |
|---|---|---|---|---|
| Anamorphic lens R1 | ∞ | 26.56 | 0 | 1.50974 |
| Anamorphic lens R2 | ∞ | | 50 | |
| Polygon mirror | ∞ | | 37.44 | |
| Correction plate R1 | ∞ | | 4 | 1.50974 |
| Correction plate R2 | ∞ | | 6 | |
| First lens R1 | −260.7688 | | 9.6 | 1.63363 |
| First lens R2 | ∞ | 65.276 | 8 | |
| Second lens R1 | ∞ | | 20 | 1.76029 |
| Second lens R2 | −131.3416 | −38.2304 | 8 | |
| Third lens R1 | −346.992 | | 12 | 1.50974 |
| Third lens R2 | −238.308 | | 236.08 | |
| Scan target surface | | | | |

The first surface 31a of the correction plate 31 of example 1 is a 2D polynomial aspheric surface (i.e., an aspheric surface represented by a polynomial for each height in the scan direction (Y axis) and the sub-scan direction (Z axis)). Additionally, a point of intersection between the tangent plane and the optical surface reference axis is a point of origin (plane center) that is set when designing the plane. The shape of the 2D polynomial aspheric surface is an amount of sag (y, z) from a point (y, z) on the tangent plane to the tangent plane at the optical surface reference axis, and is represented by the following Equation (29).

X(y, z)=1/R·(y²+z²)/[1+√{1−(κ+1)·(y²+z²)/R²}]+ΣBmn·y^{m}zⁿ (29)

In Equation (29), R is a curvature radius, κ is a conic coefficient, and Bmn is an aspheric surface coefficient of an m^{th} order in the scan direction and an n^{th} order in the sub-scan direction. To specify the detailed shape of the first surface 31a of the correction plate 31 of example 1, each coefficient applied to Equation (29) is shown in Table 2.

TABLE 2

n

| m | 0 | 2 |
|---|---|---|
| 1 | 0.000000.E+00 | 7.480850.E−06 |
| 2 | 0.000000.E+00 | −1.047494.E−06 |
| 3 | 0.000000.E+00 | −1.722148.E−08 |
| 4 | 0.000000.E+00 | 2.435566.E−09 |
| 5 | 0.000000.E+00 | 1.076782.E−11 |
| 6 | 0.000000.E+00 | −1.319627.E−12 |
| 7 | 0.000000.E+00 | 0.000000.E+00 |
| 8 | 0.000000.E+00 | 0.000000.E+00 |
| 9 | 0.000000.E+00 | 0.000000.E+00 |
| 10 | 0.000000.E+00 | 0.000000.E+00 |
| 11 | 0.000000.E+00 | 0.000000.E+00 |
| 12 | 0.000000.E+00 | 0.000000.E+00 |

Table 3 shows the simulation results of scanning properties of the light scanning apparatus 1 of example 1, and represents, in each image height Y, an incidence angle α (deg) onto the scan target surface 50, an F value, ┌Fno′²/Fno²┘ in the conditional expression (1), an upper limit value ┌1/cos α⁴┘ (in Table 3, ┌upper limits┘) in the conditional expression (1), a lower limit value ┌{1−(1−cos α⁴)/√M}┘ (in Table 3, ┌lower limit 1(M=√2)┘) when M=√2 in the conditional expression (1), and a lower limit value ┌{1−(1-cos α⁴)/√M}┘ (in Table 3, ┌lower limit 2(M=2)┘) when M=2 in the conditional expression (1). As shown in Table 3, this example is configured to satisfy the conditional expression (1) when M=√2, and does not satisfy the conditional expression (1) M=2. FIG. 8 is graphical representation of ┌Fno′²/Fno²┘, ┌upper limit┘, ┌lower limit 1(M=√2)┘ and ┌lower limit 2(M=2)┘ of Table 3, and the horizontal axis is image height Y(mm).

TABLE 3

| Image height Y | Incidence angle α | F value | Fno′²/Fno² | Upper limit | Lower limit 1 (M = \sqrt{2}) | Lower limit 2 (M = 2) |
|---|---|---|---|---|---|---|
| 108.0 | 15.75 | 36.43 | 0.976 | 1.165 | 0.964 | 0.996 |
| 94.5 | 13.91 | 36.58 | 0.984 | 1.126 | 0.972 | 0.996 |
| 81.0 | 12.00 | 36.69 | 0.990 | 1.092 | 0.978 | 0.996 |
| 67.5 | 10.04 | 36.76 | 0.994 | 1.064 | 0.985 | 0.997 |
| 54.0 | 8.04 | 36.82 | 0.997 | 1.040 | 0.990 | 0.998 |
| 40.5 | 6.01 | 36.85 | 0.999 | 1.022 | 0.994 | 0.999 |
| 27.0 | 3.95 | 36.87 | 1.000 | 1.010 | 0.998 | 0.999 |
| 13.5 | 1.88 | 36.88 | 1.000 | 1.002 | 0.999 | 1.000 |
| 0.0 | 0.00 | 36.87 | 1.000 | 1.000 | 1.000 | 1.000 |
| −13.5 | 1.88 | 36.87 | 1.000 | 1.002 | 0.999 | 1.000 |
| −27.0 | 3.95 | 36.84 | 0.999 | 1.010 | 0.998 | 0.999 |
| −40.5 | 6.01 | 36.82 | 0.997 | 1.022 | 0.994 | 0.999 |
| −54.0 | 8.04 | 36.78 | 0.995 | 1.040 | 0.990 | 0.998 |
| −67.5 | 10.04 | 36.73 | 0.992 | 1.064 | 0.985 | 0.997 |
| −81.0 | 12.00 | 36.66 | 0.989 | 1.092 | 0.978 | 0.996 |
| −94.5 | 13.91 | 36.57 | 0.983 | 1.126 | 0.972 | 0.996 |
| −108.0 | 15.75 | 36.43 | 0.976 | 1.165 | 0.964 | 0.996 |

Table 4 shows, in the light scanning apparatus 1 of example 1, the simulation results of spot diameter variation ΔW(μm) on the scan target surface 50 when the distance between the mirror retaining elements (not shown) at the two ends of the reflective mirror 40 is changed by 0.0018 mm (equivalent to linear expansion 6.7×10⁻⁷) (i.e., when the reflective mirror 40 is bent). In Table 4, ┌aberration D0 (before adjustment)┘ denotes the wavefront aberration D0 (i.e., D0 in the conditional expression (15)) at the end of the axial beam L1 by the curve of the reflective mirror 40, ┌aberration D′ (after adjustment)┘ denotes the wavefront aberration D0 (i.e., D0 in the conditional expression (15)) at the end of the axial beam L1 by the curve of the reflective mirror 40, and denotes the wavefront aberration D′ (i.e., D′ in the conditional expression (18)) of the axial beam L1 after adjustment of the wavefront aberration D0, ┌design spot diameter W0′┘ denotes the spot diameter W0′ (μm) in design (i.e., W0′ in the conditional expression (20)), ┌spot diameter W┘ denotes the spot diameter W′ (μm) (i.e., Win the conditional expression (20)) in the presence of wavefront aberration, and ┌spot diameter variation ΔW′┘ denotes the spot diameter variation ΔW′ (μm) (i.e., ΔW′ in the conditional expression (23)) on the scan target surface 50.

TABLE 4

| | Aberration | Aberration | Design | | Spot |
|---|---|---|---|---|---|
| Image | D0 | D′ | spot | Spot | diameter |
| height | (before | (after | diameter | diameter | variation |
| Y | adjustment) | adjustment) | W0′ | W′ | ΔW′ |
| 108.0 | 0.502 | 0.082 | 40.0 | 45.3 | 5.3 |
| 94.5 | 0.481 | 0.061 | 39.8 | 42.7 | 2.9 |
| 81.0 | 0.464 | 0.043 | 39.6 | 41.1 | 1.5 |
| 67.5 | 0.450 | 0.030 | 39.5 | 40.1 | 0.7 |
| 54.0 | 0.439 | 0.018 | 39.3 | 39.6 | 0.3 |
| 40.5 | 0.431 | 0.010 | 39.2 | 39.2 | 0.1 |
| 27.0 | 0.425 | 0.004 | 39.1 | 39.1 | 0.0 |
| 13.5 | 0.422 | 0.001 | 39.0 | 39.0 | 0.0 |
| 0.0 | 0.421 | 0.000 | 39.0 | 39.0 | 0.0 |
| −13.5 | 0.422 | 0.001 | 39.0 | 39.0 | 0.0 |
| −27.0 | 0.425 | 0.005 | 39.0 | 39.0 | 0.0 |
| −40.5 | 0.431 | 0.010 | 39.1 | 39.2 | 0.1 |
| −54.0 | 0.440 | 0.019 | 39.3 | 39.5 | 0.3 |
| −67.5 | 0.451 | 0.030 | 39.4 | 40.1 | 0.7 |
| −81.0 | 0.465 | 0.044 | 39.6 | 41.1 | 1.5 |
| −94.5 | 0.482 | 0.061 | 39.8 | 42.7 | 2.9 |
| −108.0 | 0.502 | 0.082 | 40.0 | 45.3 | 5.3 |

From Table 4, it can be seen that in the light scanning apparatus 1 of example 1, even when the distance between the mirror retaining elements (not shown) at the two ends of the reflective mirror 40 is changed by 0.0018 mm (equivalent to linear expansion 6.7×10⁻⁷) (i.e., even when the reflective mirror 40 is bent), the spot diameter variation ΔW′ on the scan target surface 50 falls within ±5.3 μm.

Table 5 shows the simulation results of spot diameter variation ΔW′ on the scan target surface 50 in the light scanning apparatus 1 of example 1, in the case of two reflective mirrors 40. As described above, in the case of two reflective mirrors 40, because each reflective mirror 40 is not necessarily bent in the same direction, Table 5 shows simulation of the spot diameter variation ΔW′ on the scan target surface 50 at the distance between the mirror retaining elements (not shown) at the two ends of the reflective mirror 40 that is changed √2 times (i.e., 0.0026 mm) larger than that of Table 4 (i.e., 0.0018 mm).

TABLE 5

| | Aberration | Aberration | Design | | Spot |
|---|---|---|---|---|---|
| Image | D0 | D′ | spot | Spot | diameter |
| height | (before | (after | diameter | diameter | variation |
| Y | adjustment) | adjustment) | W0′ | W′ | ΔW′ |
| 108.0 | 0.597 | 0.097 | 40.0 | 47.4 | 7.4 |
| 94.5 | 0.573 | 0.072 | 39.8 | 43.9 | 4.1 |
| 81.0 | 0.552 | 0.052 | 39.6 | 41.7 | 2.1 |
| 67.5 | 0.535 | 0.035 | 39.5 | 40.4 | 1.0 |
| 54.0 | 0.522 | 0.022 | 39.3 | 39.7 | 0.4 |
| 40.5 | 0.512 | 0.012 | 39.2 | 39.3 | 0.1 |
| 27.0 | 0.505 | 0.005 | 39.1 | 39.1 | 0.0 |
| 13.5 | 0.501 | 0.001 | 39.0 | 39.0 | 0.0 |
| 0.0 | 0.500 | 0.000 | 39.0 | 39.0 | 0.0 |
| −13.5 | 0.501 | 0.001 | 39.0 | 39.0 | 0.0 |
| −27.0 | 0.506 | 0.006 | 39.0 | 39.1 | 0.0 |
| −40.5 | 0.513 | 0.012 | 39.1 | 39.3 | 0.1 |
| −54.0 | 0.523 | 0.023 | 39.3 | 39.7 | 0.4 |
| −67.5 | 0.536 | 0.036 | 39.4 | 40.4 | 1.0 |
| −81.0 | 0.553 | 0.053 | 39.6 | 41.8 | 2.2 |
| −94.5 | 0.573 | 0.073 | 39.8 | 44.0 | 4.2 |
| −108.0 | 0.597 | 0.097 | 40.0 | 47.4 | 7.4 |

From Table 5, it can be seen that in the light scanning apparatus 1 of example 1, even when the distance between the mirror retaining elements (not shown) at the two ends of the reflective mirror 40 is changed √2 times (i.e., 0.0026 mm) larger than that of Table 4 (i.e., 0.0018 mm), the spot diameter variation ΔW′ on the scan target surface 50 falls within ±7.4 μm.

### EXAMPLE 2

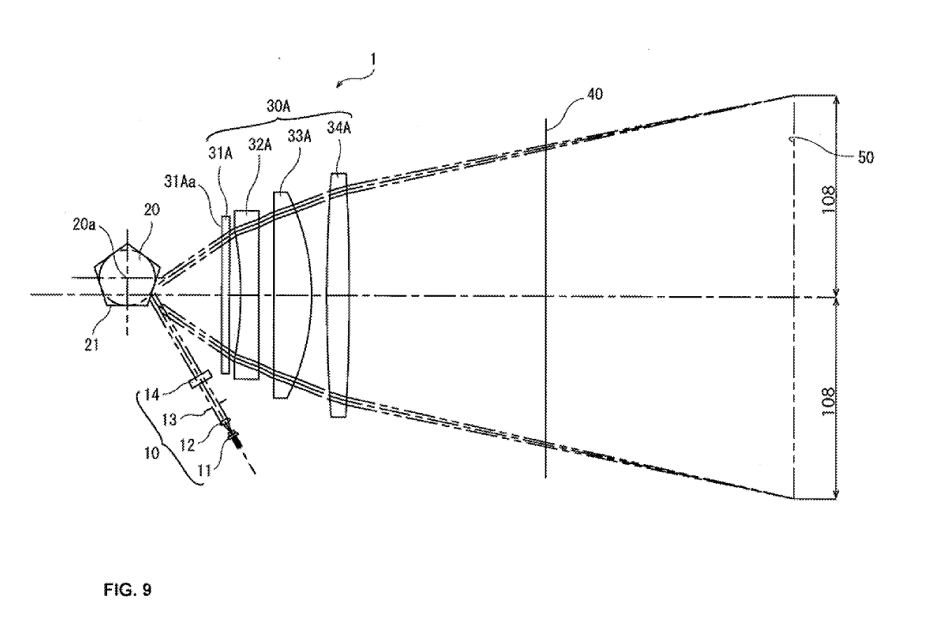

FIG. 9 is a plane view in the scan direction showing the arrangement of optical elements of the light scanning apparatus 1 of example 2. The light scanning apparatus 1 of example 2 is different from the light scanning apparatus 1 of example 1 in that it includes an image-forming optical system 30A including a correction plate 31A, a first lens 32A, a second lens 33A and a third lens 34A, and the image-forming optical system 30A has the property of Y=2f·tan(θ/2). Table 6 is a table showing the detailed numerical value configuration of this example.

TABLE 6

| Name | R | Rz | D | nλ |
|---|---|---|---|---|
| Anamorphic lens R1 | ∞ | 26.56 | | 1.50974 |
| Anamorphic lens R2 | ∞ | | 50 | |
| Polygon mirror | ∞ | | 37.44 | |
| Correction plate R1 | ∞ | | 4 | 1.50974 |
| Correction plate R2 | ∞ | | 6 | |
| First lens R1 | −263.6216 | | 9.6 | 1.63363 |
| First lens R2 | −273.5704 | 114.4504 | 8 | |
| Second lens R1 | −279.0376 | | 16 | 1.76029 |
| Second lens R2 | −129.4624 | −32.684 | 8 | |
| Third lens R1 | −189.8824 | | 16 | 1.50974 |
| Third lens R2 | −135.42 | | 232.56 | |
| Scan target surface | | | | |

Additionally, Table 7 shows each coefficient applied to Equation (29) to specify the detailed shape of a first surface 31Aa of the correction plate 31A of example 2.

TABLE 7

n

| m | 0 | 2 |
|---|---|---|
| 1 | 0.000000.E+00 | 7.218100.E−06 |
| 2 | 0.000000.E+00 | −2.761619.E−06 |
| 3 | 0.000000.E+00 | −1.878273.E−08 |
| 4 | 0.000000.E+00 | 3.074346.E−09 |
| 5 | 0.000000.E+00 | 1.283972.E−11 |
| 6 | 0.000000.E+00 | −1.345323.E−12 |
| 7 | 0.000000.E+00 | 0.000000.E+00 |
| 8 | 0.000000.E+00 | 0.000000.E+00 |
| 9 | 0.000000.E+00 | 0.000000.E+00 |
| 10 | 0.000000.E+00 | 0.000000.E+00 |
| 11 | 0.000000.E+00 | 0.000000.E+00 |
| 12 | 0.000000.E+00 | 0.000000.E+00 |

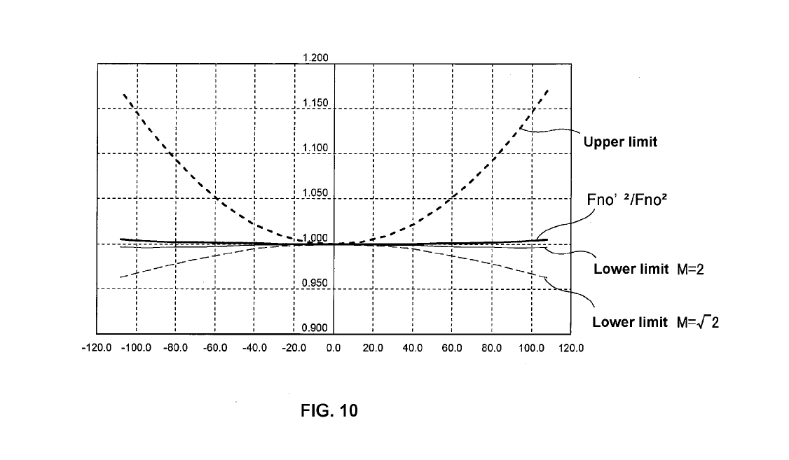

Table 8 shows the simulation results of scanning properties of the light scanning apparatus 1 of example 2. As shown in Table 8, this example is configured to satisfy the conditional expression (1) when M=√2, M=2. Additionally, FIG. 10 is graphical representation of ┌Fno′²/Fno²┘, ┌upper limit┘, ┌lower limit 1(M=√2)┘ and ┌lower limit 2(M=2)┘ of Table 8, and the horizontal axis is image height Y(mm).

TABLE 8

| Image height Y | Incidence angle α | F value | Fno′²/Fno² | Upper limit | Lower limit 1 (M = \sqrt{2}) | Lower limit 2 (M = 2) |
|---|---|---|---|---|---|---|
| 108.0 | 15.83 | 36.39 | 1.005 | 1.167 | 0.964 | 0.996 |
| 94.5 | 13.98 | 36.36 | 1.003 | 1.128 | 0.971 | 0.996 |
| 81.0 | 12.05 | 36.34 | 1.002 | 1.093 | 0.978 | 0.996 |
| 67.5 | 10.07 | 36.33 | 1.001 | 1.064 | 0.984 | 0.997 |
| 54.0 | 8.05 | 36.32 | 1.001 | 1.040 | 0.990 | 0.998 |
| 40.5 | 6.01 | 36.31 | 1.000 | 1.022 | 0.994 | 0.999 |
| 27.0 | 3.94 | 36.31 | 1.000 | 1.010 | 0.998 | 0.999 |
| 13.5 | 1.86 | 36.30 | 1.000 | 1.002 | 0.999 | 1.000 |
| 0.0 | 0.00 | 36.31 | 1.000 | 1.000 | 1.000 | 1.000 |
| −13.5 | 1.86 | 36.31 | 1.000 | 1.002 | 0.999 | 1.000 |
| −27.0 | 3.94 | 36.31 | 1.000 | 1.010 | 0.998 | 0.999 |
| −40.5 | 6.01 | 36.32 | 1.001 | 1.022 | 0.994 | 0.999 |
| −54.0 | 8.05 | 36.32 | 1.001 | 1.040 | 0.990 | 0.998 |
| −67.5 | 10.07 | 36.33 | 1.002 | 1.064 | 0.984 | 0.997 |
| −81.0 | 12.05 | 36.35 | 1.002 | 1.093 | 0.978 | 0.996 |
| −94.5 | 13.98 | 36.37 | 1.003 | 1.128 | 0.971 | 0.996 |
| −108.0 | 15.83 | 36.39 | 1.005 | 1.167 | 0.964 | 0.996 |

Table 9 shows the simulation results of spot diameter variation ΔW′ on the scan target surface 50 in the light scanning apparatus 1 of example 2, when the distance between the mirror retaining elements (not shown) at the two ends of the reflective mirror 40 is changed by 0.0018 mm (equivalent to linear expansion 6.7×10⁻⁷) (i.e., when the reflective mirror 40 is bent).

TABLE 9

| | Aberration | Aberration | Design | | Spot |
|---|---|---|---|---|---|
| Image | D0 | D′ | spot | Spot | diameter |
| height | (before | (after | diameter | diameter | variation |
| Y | adjustment) | adjustment) | W0′ | W′ | ΔW′ |
| 108.0 | 0.499 | 0.069 | 40.0 | 43.9 | 3.9 |
| 94.5 | 0.483 | 0.053 | 39.6 | 41.9 | 2.3 |
| 81.0 | 0.469 | 0.039 | 39.3 | 40.5 | 1.2 |
| 67.5 | 0.457 | 0.027 | 39.0 | 39.6 | 0.6 |
| 54.0 | 0.447 | 0.017 | 38.8 | 39.0 | 0.2 |
| 40.5 | 0.439 | 0.009 | 38.6 | 38.7 | 0.1 |
| 27.0 | 0.434 | 0.004 | 38.5 | 38.5 | 0.0 |
| 13.5 | 0.431 | 0.001 | 38.4 | 38.4 | 0.0 |
| 0.0 | 0.430 | 0.000 | 38.4 | 38.4 | 0.0 |
| −13.5 | 0.430 | 0.000 | 38.4 | 38.4 | 0.0 |
| −27.0 | 0.434 | 0.004 | 38.5 | 38.5 | 0.0 |
| −40.5 | 0.439 | 0.009 | 38.6 | 38.7 | 0.1 |
| −54.0 | 0.447 | 0.017 | 38.8 | 39.0 | 0.2 |
| −67.5 | 0.456 | 0.026 | 39.0 | 39.6 | 0.6 |
| −81.0 | 0.469 | 0.039 | 39.3 | 40.5 | 1.2 |
| −94.5 | 0.483 | 0.053 | 39.6 | 41.9 | 2.3 |
| −108.0 | 0.499 | 0.069 | 40.0 | 43.9 | 3.9 |

From Table 9, it can be seen that in the light scanning apparatus 1 of example 2, even when the distance between the mirror retaining elements (not shown) at the two ends of the reflective mirror 40 is changed by 0.0018 mm (equivalent to linear expansion 6.7×10⁻⁷) (i.e., even when the reflective mirror 40 is bent), the spot diameter variation ΔW′ on the scan target surface 50 falls within ±3.9 μm.

Table 10 shows the simulation results of spot diameter variation ΔW on the scan target surface 50 in the light scanning apparatus 1 of example 2, in the case of two reflective mirrors 40. As described above, in the case of two reflective mirrors 40, because each reflective mirror 40 is not necessarily bent in the same direction, Table 10 shows simulation of the spot diameter variation ΔW′ on the scan target surface 50 at the distance between the mirror retaining elements (not shown) at the two ends of the reflective mirror 40 that is changed 2 times (i.e., 0.0037 mm) larger than that of Table 9 (i.e., 0.0018 mm).

TABLE 10

| | Aberration | Aberration | Design | | Spot |
|---|---|---|---|---|---|
| Image | D0 | D′ | spot | Spot | diameter |
| height | (before | (after | diameter | diameter | variation |
| Y | adjustment) | adjustment) | W0′ | W′ | ΔW′ |
| 108.0 | 0.706 | 0.098 | 40.0 | 47.6 | 7.6 |
| 94.5 | 0.683 | 0.075 | 39.6 | 44.0 | 4.4 |
| 81.0 | 0.663 | 0.055 | 39.3 | 41.6 | 2.4 |
| 67.5 | 0.646 | 0.038 | 39.0 | 40.1 | 1.1 |
| 54.0 | 0.632 | 0.024 | 38.8 | 39.2 | 0.4 |
| 40.5 | 0.621 | 0.013 | 38.6 | 38.7 | 0.1 |
| 27.0 | 0.613 | 0.006 | 38.5 | 38.5 | 0.0 |
| 13.5 | 0.609 | 0.001 | 38.4 | 38.4 | 0.0 |
| 0.0 | 0.608 | 0.000 | 38.4 | 38.4 | 0.0 |
| −13.5 | 0.609 | 0.001 | 38.4 | 38.4 | 0.0 |
| −27.0 | 0.613 | 0.006 | 38.5 | 38.5 | 0.0 |
| −40.5 | 0.621 | 0.013 | 38.6 | 38.7 | 0.1 |
| −54.0 | 0.631 | 0.024 | 38.8 | 39.2 | 0.4 |
| −67.5 | 0.645 | 0.038 | 39.0 | 40.1 | 1.1 |
| −81.0 | 0.663 | 0.055 | 39.3 | 41.6 | 2.4 |
| −94.5 | 0.683 | 0.075 | 39.6 | 44.0 | 4.4 |
| −108.0 | 0.706 | 0.098 | 40.0 | 47.6 | 7.6 |

From Table 10, it can be seen that in the light scanning apparatus 1 of example 2, even when the distance between the mirror retaining elements (not shown) at the two ends of the reflective mirror 40 is changed 2 times (i.e., 0.0037 mm) larger than that of Table 9 (i.e., 0.0018 mm), the spot diameter variation ΔW′ on the scan target surface 50 falls within ±7.6 μm.

### COMPARATIVE EXAMPLE 1

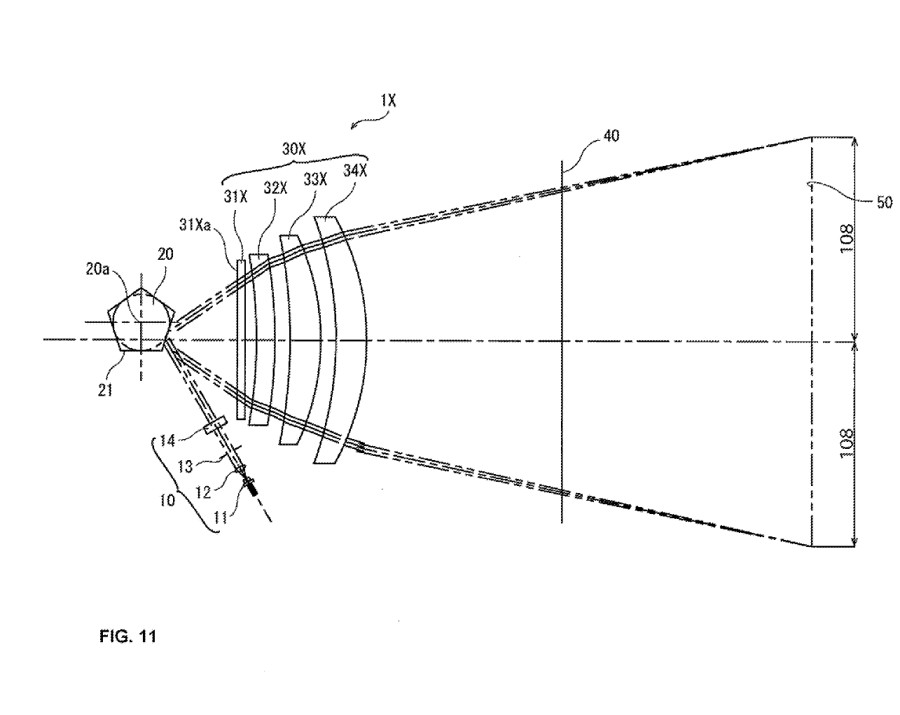

FIG. 11 is a plane view in the scan direction showing the arrangement of optical elements of a light scanning apparatus 1X of comparative example 1. The light scanning apparatus 1X of comparative example 1 is different from the light scanning apparatus 1 of example 1 and example 2 in that it includes an image-forming optical system 30X including a correction plate 31X, a first lens 32X, a second lens 33X and a third lens 34X, and the image-forming optical system 30X has the property of Y=fθ. Table 11 is a table showing the detailed numerical value configuration of this comparative example.

TABLE 11

| Name | R | Rz | D | nλ |
|---|---|---|---|---|
| Anamorphic lens R1 | ∞ | 26.56 | | 1.50974 |
| Anamorphic lens R2 | ∞ | | 50 | |
| Polygon mirror | ∞ | | 37.44 | |
| Correction plate R1 | ∞ | | 4 | 1.50974 |
| Correction plate R2 | ∞ | | 6 | |
| First lens R1 | −185.1088 | | 9.6 | 1.63363 |
| First lens R2 | ∞ | 69.6416 | 8 | |
| Second lens R1 | ∞ | | 20 | 1.76029 |
| Second lens R2 | −122.6512 | −33.8784 | 8 | |
| Third lens R1 | 901.2768 | | 12 | 1.50974 |
| Third lens R2 | −1122.225 | | 235.92 | |
| Scan target surface | | | | |

Additionally, Table 12 shows each coefficient applied to Equation (29) to specify the detailed shape of a first surface 31Xa of the correction plate 31X of comparative example 1.

TABLE 12

n

| m | 0 | 2 |
|---|---|---|
| 1 | 0.000000.E+00 | 5.571900.E−07 |
| 2 | 0.000000.E+00 | −4.803006.E−07 |
| 3 | 0.000000.E+00 | −8.397891.E−09 |
| 4 | −1.300697.E−08 | 2.006885.E−09 |
| 5 | 0.000000.E+00 | 4.921472.E−12 |
| 6 | 2.261130.E−11 | −1.238916.E−12 |
| 7 | 0.000000.E+00 | 0.000000.E+00 |
| 8 | −2.671299.E−14 | 0.000000.E+00 |
| 9 | 0.000000.E+00 | 0.000000.E+00 |
| 10 | 1.702465.E−17 | 0.000000.E+00 |
| 11 | 0.000000.E+00 | 0.000000.E+00 |
| 12 | −5.301624.E−21 | 0.000000.E+00 |

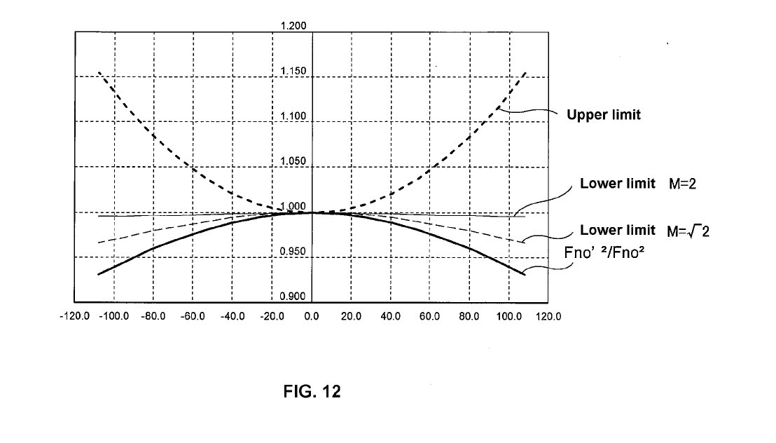

Table 13 shows the simulation results of scanning properties of the light scanning apparatus 1X of comparative example 1. As shown in Table 13, this comparative example does not satisfy the conditional expression (1) when M=√2, M=2. Additionally, FIG. 12 is graphical representation of ┌Fno′²/Fno²┘, ┌upper limit┘, ┌lower limit 1(M=√2)┘ and ┌lower limit 2(M=2)┘ of Table 13, and the horizontal axis is image height Y(mm).

TABLE 13

| Image height Y | Incidence angle α | F value | Fno′²/Fno² | Upper limit | Lower limit 1(M = \sqrt{2}) | Lower limit 2 (M = 2) |
|---|---|---|---|---|---|---|
| 108.0 | 15.51 | 36.49 | 0.929 | 1.160 | 0.965 | 0.996 |
| 94.5 | 13.66 | 36.78 | 0.944 | 1.122 | 0.972 | 0.996 |
| 81.0 | 11.83 | 37.05 | 0.958 | 1.090 | 0.979 | 0.997 |
| 67.5 | 9.94 | 37.28 | 0.970 | 1.062 | 0.985 | 0.997 |
| 54.0 | 7.99 | 37.48 | 0.981 | 1.040 | 0.990 | 0.998 |
| 40.5 | 6.00 | 37.64 | 0.989 | 1.022 | 0.994 | 0.999 |
| 27.0 | 3.99 | 37.76 | 0.995 | 1.010 | 0.997 | 0.999 |
| 13.5 | 1.95 | 37.83 | 0.999 | 1.002 | 0.999 | 1.000 |
| 0.0 | 0.00 | 37.85 | 1.000 | 1.000 | 1.000 | 1.000 |
| −13.5 | 1.95 | 37.83 | 0.999 | 1.002 | 0.999 | 1.000 |
| −27.0 | 3.99 | 37.76 | 0.995 | 1.010 | 0.997 | 0.999 |
| −40.5 | 6.00 | 37.64 | 0.989 | 1.022 | 0.994 | 0.999 |
| −54.0 | 7.99 | 37.48 | 0.981 | 1.040 | 0.990 | 0.998 |
| −67.5 | 9.94 | 37.28 | 0.970 | 1.062 | 0.985 | 0.997 |
| −81.0 | 11.83 | 37.05 | 0.958 | 1.090 | 0.979 | 0.997 |
| −94.5 | 13.66 | 36.78 | 0.944 | 1.122 | 0.972 | 0.996 |
| −108.0 | 15.51 | 36.49 | 0.929 | 1.160 | 0.965 | 0.996 |

Table 14 shows the simulation results of spot diameter variation ΔW on the scan target surface 50 in the light scanning apparatus 1X of comparative example 1, when the distance between the mirror retaining elements (not shown) at the two ends of the reflective mirror 40 is changed by 0.0018 mm (equivalent to linear expansion 6.7×10⁻⁷) (i.e., when the reflective mirror 40 is bent).

TABLE 14

| | Aberration | Aberration | Design | | Spot |
|---|---|---|---|---|---|
| Image | D0 | D′ | spot | Spot | diameter |
| height | (before | (after | diameter | diameter | variation |
| Y | adjustment) | adjustment) | W0′ | W′ | ΔW′ |
| 108.0 | 0.498 | 0.099 | 40.0 | 47.8 | 7.7 |
| 94.5 | 0.474 | 0.075 | 40.0 | 44.4 | 4.4 |
| 81.0 | 0.454 | 0.055 | 40.0 | 42.4 | 2.4 |
| 67.5 | 0.437 | 0.038 | 40.0 | 41.1 | 1.1 |
| 54.0 | 0.423 | 0.024 | 40.0 | 40.5 | 0.5 |
| 40.5 | 0.413 | 0.013 | 40.0 | 40.1 | 0.1 |
| 27.0 | 0.405 | 0.006 | 40.0 | 40.0 | 0.0 |
| 13.5 | 0.401 | 0.001 | 40.0 | 40.0 | 0.0 |
| 0.0 | 0.399 | 0.000 | 40.0 | 40.0 | 0.0 |
| −13.5 | 0.401 | 0.001 | 40.0 | 40.0 | 0.0 |
| −27.0 | 0.405 | 0.006 | 40.0 | 40.0 | 0.0 |
| −40.5 | 0.413 | 0.013 | 40.0 | 40.1 | 0.1 |
| −54.0 | 0.423 | 0.024 | 40.0 | 40.5 | 0.5 |
| −67.5 | 0.437 | 0.038 | 40.0 | 41.1 | 1.1 |
| −81.0 | 0.454 | 0.055 | 40.0 | 42.4 | 2.4 |
| −94.5 | 0.474 | 0.075 | 40.0 | 44.4 | 4.4 |
| −108.0 | 0.498 | 0.099 | 40.0 | 47.8 | 7.7 |

From Table 14, it can be seen that in the light scanning apparatus 1X of comparative example 1, when the distance between the mirror retaining elements (not shown) at the two ends of the reflective mirror 40 is changed by 0.0018 mm (equivalent to linear expansion 6.7×10⁻⁷) (i.e., when the reflective mirror 40 is bent), the spot diameter variation ΔW′ on the scan target surface 50 is ±7.7 μm.

### COMPARISON OF EXAMPLE 1 AND COMPARATIVE EXAMPLE 1

When comparing Table 4 and Table 14, it can be seen that the spot diameter variation ΔW′ (±5.3 μm) of the light scanning apparatus 1 of example 1 is smaller than the spot diameter variation ΔW′ (±7.7 μm) of the light scanning apparatus 1X of comparative example 1. Additionally, when comparing Table 5 and Table 14, it can be seen that in the light scanning apparatus 1 of example 1, even in the case of two reflective mirrors 40, the spot diameter variation ΔW′ (±7.4 μm) is smaller than the spot diameter variation ΔW′ (±7.7 μm) of the light scanning apparatus 1A of comparative example 1.

### COMPARISON OF EXAMPLE 2 AND COMPARATIVE EXAMPLE 1

When comparing Table 9 and Table 14, it can be seen that the spot diameter variation ΔW′ (±3.9 μm) of the light scanning apparatus 1 of example 2 is smaller than the spot diameter variation ΔW′ (±7.7 μm) of the light scanning apparatus 1X of comparative example 1. Additionally, when comparing Table 10 and Table 14, it can be seen that in the light scanning apparatus 1 of example 2, even in the case of two reflective mirrors 40, the spot diameter variation ΔW′ (±7.6 μm) is smaller than the spot diameter variation ΔW′ (±7.7 μm) of the light scanning apparatus 1X of comparative example 1.

As described above, the light scanning apparatus 1 of this embodiment is configured to satisfy the conditional expression (1), thereby reducing the occurrence of the upper surface bending caused by the curve of the reflective mirror 40. Additionally, the image-forming optical system 30 of this embodiment is configured to have the properties of Y=2f·tan(θ/2), Y=3f·tan(θ/3) so that the properties smoothly change between axial (i.e., image height 0 mm) and maximum image height ±108 mm.

While the embodiments of the present disclosure have been hereinabove described, the present disclosure is not limited to the configuration of the above-described embodiments, and various modifications may be made within the scope of the technical spirit.

For example, although the image-forming optical system 30 of this embodiment has the properties of Y=2f·tan(θ/2), Y=3f·tan(θ/3), it may have the intermediate property of Y=fθ and Y=f·tanθ, and may be configured to have the property represented by the above-described conditional expression (2) as below.

Y=Nf·tan(θ/N) (2)

where N is an arbitrary real number that is 2 or greater and 10 or smaller.

Additionally, as described above, in the conditional expression (2), when N=1, Y=fθ and when N→∞, Y=·tanθ.

(Variation of the Image-Forming Optical System 30)

Additionally, when the property of the image-forming optical system 30 is the intermediate property of Y=fθ and Y=f·tanθ as in the conditional expression (2), there is a problem that with the increasing incidence angle θ (i.e., increasing image height), the scanning speed of laser beam is faster (FIG. 7) as described above. Thus, in this embodiment, the modulation frequency of the semiconductor laser 11 changes depending on the scan position of laser beam (i.e., depending on the image height), thereby absorbing a change in scanning speed of laser beam, and between axial (i.e., image height 0 mm) and maximum image height ±108 mm, a large difference in scanning speed results in a large width of change in the modulation frequency, so there is a problem that the circuit configuration for driving (modulating) the semiconductor laser 11 becomes complex. Accordingly, to solve this problem, the image-forming optical system 30 may be configured to have a plurality of properties (for example, the property of Y=3f·tan(θ/3) and the property of Y=4f·tan(θ/4)) in combination as shown in the following example 3.

### EXAMPLE 3

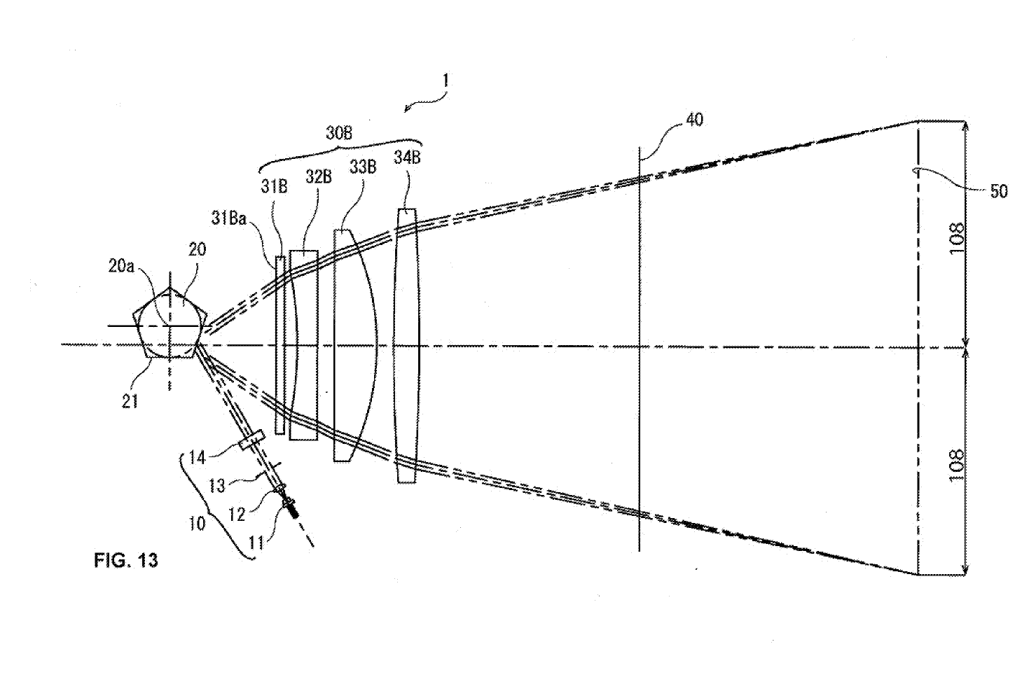

FIG. 13 is a plane view in the scan direction showing the arrangement of optical elements of the light scanning apparatus 1 of example 3. The light scanning apparatus 1 of example 3 is different from the light scanning apparatus 1 of examples 1 and 2 in that it includes an image-forming optical system 30B including a correction plate 31B, a first lens 32B, a second lens 33B and a third lens 34B, and the image-forming optical system 30B has an acceleration change property equivalent to Y=3f·tan(θ/3) at the axial (i.e., image height 0 mm) and a scanning speed property equivalent to Y=4f·tan(θ/4) at the maximum image height±108 mm. Table 15 is a table showing the detailed numerical value configuration of this example.

TABLE 15

| Name | R | Rz | D | nλ |
|---|---|---|---|---|
| Anamorphic lens R1 | ∞ | 26.56 | | 1.50974 |
| Anamorphic lens R2 | ∞ | | 50 | |
| Polygon mirror | ∞ | | 39.62 | |
| Correction plate R1 | ∞ | | 4 | 1.50974 |
| Correction plate R2 | ∞ | | 6 | |
| First lens R1 | −243.4968 | | 9.6 | 1.63363 |
| First lens R2 | ∞ | 66.9352 | 8 | |
| Second lens R1 | ∞ | | 20 | 1.76029 |
| Second lens R2 | −133.5592 | −34.2152 | 8 | |
| Third lens R1 | −1130.704 | | 12 | 1.50974 |
| Third lens R2 | −378.8448 | | 233.42 | |
| Scan target surface | | | | |

Additionally, Table 16 shows each coefficient applied to Equation (29) to specify the detailed shape of a first surface 31Ba of the correction plate 31B of example 3.

TABLE 16

n

| m | 0 | 2 |
|---|---|---|
| 1 | 0.000000.E+00 | 8.465125.E−06 |
| 2 | −5.244475.E−07 | −9.062109.E−07 |
| 3 | 0.000000.E+00 | −1.975518.E−08 |
| 4 | 2.927168.E−09 | 2.542688.E−09 |
| 5 | 0.000000E+00 | 1.632111.E−11 |
| 6 | 8.106110.E−12 | −1.559195.E−12 |
| 7 | 0.000000.E+00 | −4.849744.E−15 |
| 8 | −4.363027.E−15 | 2.131996.E−16 |
| 9 | 0.000000.E+00 | 0.000000.E+00 |
| 10 | 0.000000.E+00 | 0.000000.E+00 |
| 11 | 0.000000.E+00 | 0.000000.E+00 |
| 12 | 0.000000.E+00 | 0.000000.E+00 |

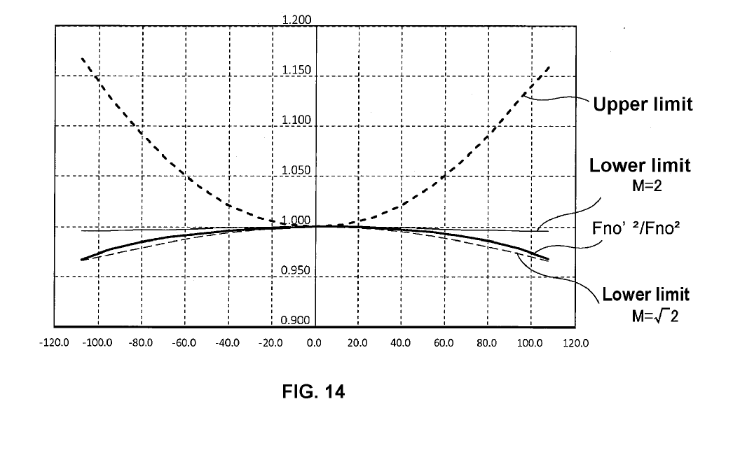

Table 17 shows the simulation results of scanning properties of the light scanning apparatus 1 of example 3. As shown in Table 17, this example is configured to satisfy the conditional expression (1) when M=√2, M=2. Additionally, FIG. 14 is graphical representation of ┌Fno′²/Fno²┘, ┌upper limit┘, ┌lower limit 1(M=√2)┘, ┌lower limit 2(M=2)┘) of Table 17, and the horizontal axis is image height Y(mm).

TABLE 17

| Image height Y | Incidence angle α | F value | Fno′²/Fno² | Upper limit | Lower limit 1 (M = \sqrt{2}) | Lower limit 2 (M = 2) |
|---|---|---|---|---|---|---|
| 108.0 | 15.45 | 35.77 | 0.967 | 1.159 | 0.966 | 0.996 |
| 94.5 | 13.64 | 35.96 | 0.978 | 1.128 | 0.973 | 0.996 |
| 81.0 | 11.77 | 36.10 | 0.985 | 1.093 | 0.979 | 0.997 |
| 67.5 | 9.85 | 36.21 | 0.991 | 1.064 | 0.985 | 0.997 |
| 54.0 | 7.89 | 36.28 | 0.995 | 1.040 | 0.990 | 0.998 |
| 40.5 | 5.90 | 36.32 | 0.997 | 1.022 | 0.995 | 0.999 |
| 27.0 | 3.88 | 36.35 | 0.999 | 1.010 | 0.998 | 0.999 |
| 13.5 | 1.86 | 36.36 | 1.000 | 1.002 | 0.999 | 1.000 |
| 0.0 | 0.19 | 36.37 | 1.000 | 1.000 | 1.000 | 1.000 |
| −13.5 | 2.20 | 36.36 | 0.999 | 1.002 | 0.999 | 1.000 |
| −27.0 | 4.21 | 36.33 | 0.998 | 1.010 | 0.997 | 0.999 |
| −40.5 | 6.20 | 36.29 | 0.996 | 1.022 | 0.994 | 0.999 |
| −54.0 | 8.16 | 36.25 | 0.993 | 1.040 | 0.990 | 0.998 |
| −67.5 | 10.08 | 36.17 | 0.989 | 1.064 | 0.984 | 0.997 |
| −81.0 | 11.96 | 36.08 | 0.984 | 1.093 | 0.979 | 0.997 |
| −94.5 | 13.77 | 35.95 | 0.977 | 1.128 | 0.972 | 0.996 |
| −108.0 | 15.51 | 35.76 | 0.967 | 1.167 | 0.965 | 0.996 |

Table 18 shows, in the light scanning apparatus 1 of example 3, the simulation results of spot diameter variation ΔW′ on the scan target surface 50 when the distance between the mirror retaining elements (not shown) at the two ends of the reflective mirror 40 is changed by 0.0018 mm (equivalent to linear expansion 6.7×10⁻⁷) (i.e., when the reflective mirror 40 is bent).

TABLE 18

| | Aberration | Aberration | Design | | Spot |
|---|---|---|---|---|---|
| Image | D0 | D′ | spot | Spot | diameter |
| height | (before | (after | diameter | diameter | variation |
| Y | adjustment) | adjustment) | W0′ | W′ | ΔW′ |
| 108.0 | 0.498 | 0.082 | 40.0 | 45.5 | 5.5 |
| 94.5 | 0.477 | 0.061 | 40.2 | 43.2 | 3.0 |
| 81.0 | 0.459 | 0.044 | 40.4 | 41.9 | 1.6 |
| 67.5 | 0.445 | 0.029 | 40.5 | 41.2 | 0.7 |
| 54.0 | 0.434 | 0.018 | 40.6 | 40.8 | 0.3 |
| 40.5 | 0.426 | 0.010 | 40.6 | 40.7 | 0.1 |
| 27.0 | 0.420 | 0.004 | 40.6 | 40.7 | 0.0 |
| 13.5 | 0.417 | 0.001 | 40.7 | 40.7 | 0.0 |
| 0.0 | 0.416 | 0.000 | 40.7 | 40.7 | 0.0 |
| −13.5 | 0.417 | 0.002 | 40.6 | 40.6 | 0.0 |
| −27.0 | 0.421 | 0.005 | 40.6 | 40.6 | 0.0 |
| −40.5 | 0.427 | 0.012 | 40.6 | 40.7 | 0.1 |
| −54.0 | 0.436 | 0.020 | 40.5 | 40.9 | 0.3 |
| −67.5 | 0.447 | 0.032 | 40.4 | 41.3 | 0.8 |
| −81.0 | 0.461 | 0.045 | 40.3 | 42.0 | 1.7 |
| −94.5 | 0.478 | 0.063 | 40.2 | 43.4 | 3.0 |
| −108.0 | 0.499 | 0.083 | 40.0 | 45.6 | 5.4 |

From Table 18, it can be seen that in the light scanning apparatus 1 of example 3, even when the distance between the mirror retaining elements (not shown) at the two ends of the reflective mirror 40 is changed by 0.0018 mm (equivalent to linear expansion 6.7×10⁻⁷) (i.e., even when the reflective mirror 40 is bent), the spot diameter variation ΔW′ on the scan target surface 50 falls within ±5.5 μm.

Table 19 shows the simulation results of spot diameter variation ΔW′ on the scan target surface 50 in the light scanning apparatus 1 of example 3, in the case of two reflective mirrors 40. As described above, in the case of two reflective mirrors 40, because each reflective mirror 40 is not necessarily bent in the same direction, Table 19 shows the simulation of spot diameter variation ΔW′ on the scan target surface 50 when the distance between the mirror retaining elements (not shown) at the two ends of the reflective mirror 40 is changed twice (i.e., 0.0037 mm) as much as that (i.e., 0.0018 mm) of Table 18.

TABLE 19

| | Aberration | Aberration | Design | | Spot |
|---|---|---|---|---|---|
| Image | D0 | D′ | spot | Spot | diameter |
| height | (before | (after | diameter | diameter | variation |
| Y | adjustment) | adjustment) | W0′ | W′ | ΔW′ |
| 108.0 | 0.704 | 0.116 | 40.0 | 47.57 | 7.7 |
| 94.5 | 0.674 | 0.086 | 39.6 | 44.05 | 4.3 |
| 81.0 | 0.650 | 0.062 | 39.3 | 41.64 | 2.2 |
| 67.5 | 0.630 | 0.042 | 39.0 | 40.11 | 1.0 |
| 54.0 | 0.614 | 0.026 | 38.8 | 39.21 | 0.4 |
| 40.5 | 0.602 | 0.014 | 38.6 | 38.72 | 0.1 |
| 27.0 | 0.594 | 0.006 | 38.5 | 38.48 | 0.0 |
| 13.5 | 0.589 | 0.001 | 38.4 | 33.39 | 0.0 |
| 0.0 | 0.588 | 0.000 | 38.4 | 38.37 | 0.0 |
| −13.5 | 0.590 | 0.002 | 38.4 | 38.39 | 0.0 |
| −27.0 | 0.596 | 0.008 | 38.5 | 38.49 | 0.0 |
| −40.5 | 0.605 | 0.017 | 38.6 | 38.72 | 0.2 |
| −54.0 | 0.617 | 0.029 | 38.8 | 39.21 | 0.5 |
| −67.5 | 0.633 | 0.045 | 39.0 | 40.10 | 1.2 |
| −81.0 | 0.652 | 0.064 | 39.3 | 41.63 | 2.4 |
| −94.5 | 0.676 | 0.088 | 39.6 | 44.04 | 4.3 |
| −108.0 | 0.705 | 0.117 | 40.0 | 47.57 | 7.6 |

From Table 19, it can be seen that in the light scanning apparatus 1 of example 3, even when the distance between the mirror retaining elements (not shown) at the two ends of the reflective mirror 40 is changed twice (i.e., 0.0037 mm) as much as that (i.e., 0.0018 mm) of Table 18, the spot diameter variation ΔW′ on the scan target surface 50 falls within ±7.7 μm.

### COMPARISON OF EXAMPLE 3 AND COMPARATIVE EXAMPLE 1

When comparing Table 18 and Table 14, it can be seen that the spot diameter variation ΔW′ (±5.5 μm) of the light scanning apparatus 1 of example 3 is smaller than the spot diameter variation ΔW′ (±7.7 μm) of the light scanning apparatus 1X of comparative example 1. Additionally, when comparing Table 19 and Table 14, it can be seen that in the light scanning apparatus 1 of example 3, even in the case of two reflective mirrors 40, the spot diameter variation ΔW′ (±7.7 μm) is equal to the spot diameter variation ΔW′ (±7.7 μm) of the light scanning apparatus 1A of comparative example 1.

As described above, the light scanning apparatus 1 of this variation is configured to satisfy the conditional expression (1), thereby reducing the occurrence of the upper surface bending caused by the curve of the reflective mirror 40.

Additionally, the image-forming optical system 30 of this embodiment is configured to slowly change from the property of Y=3f·tan(θ/3) to the property of Y=4f·tan(θ/4) between axial (i.e., image height 0 mm) and maximum image height ±108 mm.

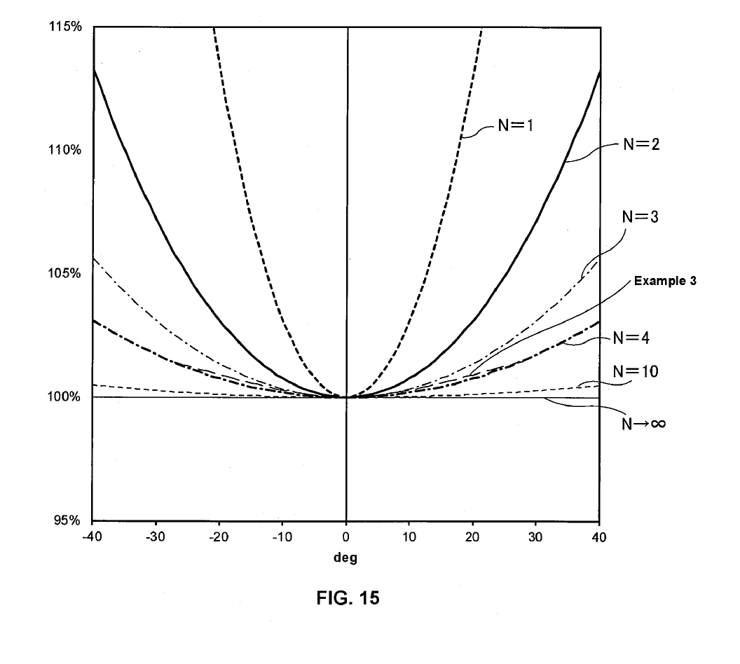

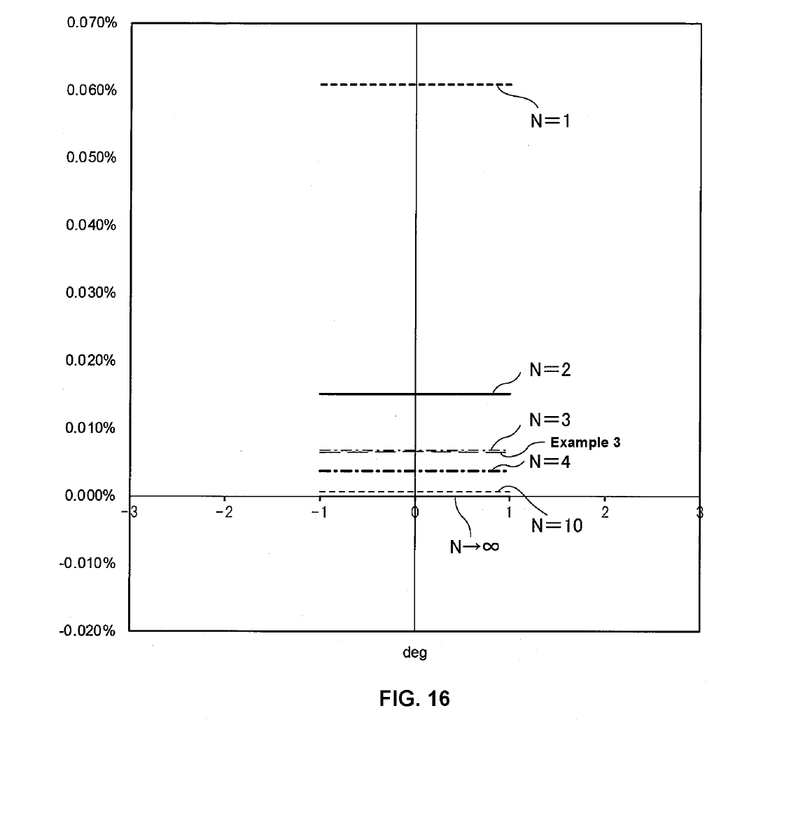

FIG. 15 is a graph showing differentiation with respect to the incidence angle θ of the image height standardized by the focal length of laser beam of the light scanning apparatus 1 of example 3. Additionally, FIG. 16 is a graph showing third order differentiation with respect to the incidence angle θ of the image height standardized by the focal length of laser beam of the light scanning apparatus 1 of example 3. Because the incidence angle θ changes in proportion to the time, FIG. 15 is equivalent to a graph showing the scanning speed of the image height of laser beam of the light scanning apparatus 1 of example 3, and FIG. 16 is equivalent to a graph showing changes in acceleration of laser beam of the light scanning apparatus 1 of example 3. Additionally, in addition to the property of the image-forming optical system 30B of example 3, FIGS. 15 and 16 show each property of Y=Nf·tan(θ/N) (where N=1, 2, 3, 4, 10, ∞) for convenience of description. Additionally, in FIG. 15, the horizontal axis is the incidence angle θ (deg), and the vertical axis is a relative scanning speed (%) when the scanning speed of axial (i.e., image height 0 mm) laser beam is 100%. Additionally, in FIG. 16, the horizontal axis is the incidence angle θ (deg) near the image height 0 mm, and the vertical axis is a relative acceleration change (%) when N→∞ (i.e., Y=f·tanθ) is 0%.

As described above, because the image-forming optical system 30B of example 3 has the property of Y=3f·tan(θ/3) at the axial (i.e., image height 0 mm) and the property of Y=4f·tan(θ/4) at the maximum image height ±108 mm, the scanning speed and acceleration changes depending on the property of Y=3f·tan(θ/3) near the image height 0 mm (FIGS. 15 and 16), and it can be seen that from the image height 0 to the maximum image height, it slowly departs from the property of Y=3f·tan(θ/3) and becomes the scanning speed according to the property of Y=4f·tan(θ/4) at the position of the maximum image height ±108 mm (equivalent to the incidence angle θ=±27 (deg) of FIG. 15) (FIG. 15). That is, the image-forming optical system 30B of example 3 has a small change in scanning speed at the image height 0 mm and the maximum image height ±108 mm compared to the image-forming optical system 30 (example 1) of the property of Y=3f·tan(θ/3). Accordingly, according to the configuration of example 3, because it is possible to reduce the width of change in the modulation frequency of the semiconductor laser 11, the circuit configuration for driving (modulating) the semiconductor laser 11 may be simplified.

Additionally, the image-forming optical system 30B of example 3 has the combined property of the property of Y=3f·tan(θ/3) and the property of Y=4f·tan(θ/4), but is not limited to this configuration, and may be generalized as below. That is, the acceleration change property (i.e., third order differentiation of image height) at the image height 0 mm of the image-forming optical system 30B may be equalized to the acceleration change property of Y=Nf·tan(θ/N) (where N is a real number that is 2 or greater and 10 or smaller), and the scanning speed property (i.e., differentiation of image height) at the maximum image height ±108 mm may be equalized to the scanning speed property of Y=N′f·tan(θ/N′) (where N′ is a real number that is 2 or greater and 10 or smaller). Additionally, a necessary and sufficient condition satisfying this configuration is that N and N′ satisfy the following Equations (30) and (31) respectively.

d³(Y/f)/dθ³=2/N²×(π/180)² (30)

d(Y/f)/dθ=1/cos(θ/N′)² (31)

Additionally, in the case of example 3, when N=3, N′=4, and the incidence angle θ=0.471(rad) at the maximum image height are substituted to Equations (30) and (31),

Value of the left-hand side of Equation (30): d³(Y/f)/dθ³=0.0000677

Value of the right-hand side of Equation (30): 2/3²×(π/180)²=0.0000677

Value of the left-hand side of Equation (31): d(Y/f)/dθ=1.014

Value of the right-hand side of Equation (31): 1/cos(θ/N′)²=1.014

and in this regard, it can be seen that in the case of example 3, Equations (30) and (31) are also satisfied.

Additionally, when a difference between N and N′ is larger than 1, the degree of aspheric surface of the image-forming optical system 30B is large, the aberration is large and the manufacturing is made difficult, and thus it is desirable to satisfy the following conditional expression (32):

0≤N′−N≤1 (32)

Additionally, in this case, to reduce changes in acceleration of laser beam at the image height 0 mm, N is preferably 2 or greater and 3 or smaller (FIG. 16). In addition, when the property of the image-forming optical system 30B is represented as Y=nf·tan(θ/n), n is preferably configured to monotonically increase from N to N′ toward the maximum image height ±108 mm from the image height 0.

Additionally, it should be understood that the disclosed embodiments are illustrative in all aspects and are not limitative. The scope of the present disclosure is defined by the appended claims rather than the foregoing description, and is intended to cover all changes within the appended claims and their equivalent meaning and scope.

### DETAILED DESCRIPTION OF MAIN ELEMENTS

1 . . . Light scanning apparatus

10 . . . Light source unit

11 . . . Semiconductor laser

12 . . . Collimator lens

13 . . . Slit

14 . . . Anamorphic lens

20 . . . Polygon mirror

20a . . . Rotation axis

21 . . . Reflective surface

30, 30A, 30X, 30B . . . Image-forming optical system

31, 31A, 31X, 31B . . . Correction plate

31a, 32a, 33a, 34a, 31Aa, 31Xa, 31Ba . . . First surface

31b, 32b, 33b, 34b . . . Second surface

32, 32A, 32X, 32B . . . First lens

33, 33A, 33X, 33B . . . Second lens

34, 34A, 34X, 34B . . . Third lens

40 . . . Reflective mirror

50 . . . Scan target surface

1. A light scanning apparatus comprising:
a laser light source which emits a laser beam;
an anamorphic element which converges the laser beam emitted from the laser light source primarily in a sub-scan direction;
a deflector which deflects and scans the laser beam converged by the anamorphic element;
an image-forming optical system which converges the laser beam deflected by the deflector as a spot scanning in a scan direction onto a scan target surface; and
a reflective member positioned between the image-forming optical system and the scan target surface to reflect the laser beam emitted from the image-forming optical system onto the scan target surface,
wherein when an F value of axial beam of the image-forming optical system in the scan direction is Fno, an F value of beam at a maximum image height in the scan direction is Fno′, and an incidence angle of beam at the maximum image height onto the scan target surface in the scan direction is a, the following Equation (1) is satisfied:
{1-(1-cos α⁴)/√M}/cos α⁴≤Fno′²/Fno²≤1/cos α⁴ (1)
where M is an arbitrary real number that is √2 or greater and 2 or smaller.

2. The light scanning apparatus according to claim 1, wherein the image-forming optical system has a property represented by the following Equation (2) when an image height is Y, a focal length is f, and an incidence angle of laser beam is θ:
Y=Nf·tan(θ/N) (2)
where N is an arbitrary real number that is 2 or greater and 10 or smaller.

3. The light scanning apparatus according to claim 1, wherein the image-forming optical system satisfies the following Equation (3) at an image height 0, and when an incidence angle of laser beam at a maximum image height is 0, the image-forming optical system satisfies the following Equation (4):
d³(Y/f)/dθ³=2/N²×(π/180)² (3)
d(Y/f)/dθ=1/cos(θ/N)² (4)
where each of N and N′ is an arbitrary real number that is 2 or greater and 10 or smaller, and satisfies the following Equation (5):
0≤N′−N≤1 (5)

4. The light scanning apparatus according to claim 3, wherein when an image height is Y and a focal length is f, the image-forming optical system has a property represented by the following Equation (6):
Y=nf·tan(θ/n) (6)
where n monotonically increases from N to N′ toward the maximum image height from the image height 0.

5. The light scanning apparatus according to claim 2, wherein the N is 2 or greater and 3 or smaller.

6. The light scanning apparatus according to claim 1, wherein the reflective member includes a first reflective mirror and a second reflective mirror each with an approximately planar mirror surface,
the first reflective mirror reflects the laser beam emitted from the image-forming optical system onto the second reflective mirror, and
the second reflective mirror reflects the laser beam emitted from the first reflective mirror onto the scan target surface.

7. The light scanning apparatus according to claim 3, wherein the N is 2 or greater and 3 or smaller.

8. The light scanning apparatus according to claim 4, wherein the N is 2 or greater and 3 or smaller.

9. The light scanning apparatus according to claim 2, wherein the reflective member includes a first reflective mirror and a second reflective mirror each with an approximately planar mirror surface,
the first reflective mirror reflects the laser beam emitted from the image-forming optical system onto the second reflective mirror, and
the second reflective mirror reflects the laser beam emitted from the first reflective mirror onto the scan target surface.

10. The light scanning apparatus according to claim 3, wherein the reflective member includes a first reflective mirror and a second reflective mirror each with an approximately planar mirror surface,
the first reflective mirror reflects the laser beam emitted from the image-forming optical system onto the second reflective mirror, and
the second reflective mirror reflects the laser beam emitted from the first reflective mirror onto the scan target surface.
